(19) United States
(12) Patent Application Publication
(10) Pub. No.: US 2025/0301132 A1
(43) Pub. Date: Sep. 25, 2025

(54) ATTENTION MAP NORMALIZATION FOR IN-LOOP FILTERING FOR VIDEO CODING

(71) Applicant: QUALCOMM Incorporated, San Diego, CA (US)

(72) Inventors: Yun Li, Ottobrunn (DE); Dmytro Rusanovskyy, San Diego, CA (US); Marta Karczewicz, San Diego, CA (US)

(21) Appl. No.: 19/065,272

(22) Filed: Feb. 27, 2025

Related U.S. Application Data
(60) Provisional application No. 63/567,841, filed on Mar. 20, 2024.

(51) Int. Cl. H04N 19/117; H04N 19/176; H04N 19/82

(52) U.S. Cl. CPC H04N 19/117; H04N 19/176; H04N 19/82

(57) ABSTRACT

A method of processing video data includes receiving, with a neural network in-loop filter (NN-ILF), a current block of video data of a current picture; and filtering, with the NN-ILF, the current block of video data to generate a filtered current block of video data, wherein filtering the current block of video data comprises: generating, with an attention block of the NN-ILF, an attention map indicative of a correlation between elements of features of the current block of video data; modifying, with the attention block of the NN-ILF, the attention map based on a size of blocks used for training the NN-ILF to generate a modified attention map; generating, with the attention block of NN-ILF, feature data based on the modified attention map; and filtering, with the NN-ILF, the current block of video data based on the feature data to generate the filtered current block of video data.

This application claims the benefit of U.S. Provisional Patent Application 63/567,841, filed Mar. 20, 2024, the entire content of which is incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for integration of hardware-friendly attention blocks into residual network (ResNet)-based in-loop filtering (ILF) architecture(s) for purposes of video coding. In one or more examples, an algorithm may be used to normalize an attention map, corresponding features, or activations produced by using the attention map.

The output of an attention block may include feature data that is used by sequential backbone blocks for filtering a current block of video data. Part of generating the feature data may include generating an attention map that is then normalized in a hardware-friendly manner. An attention map may be indicative of correlation between elements of the feature data of the current block of video data (e.g., cross-correlation/correlation computed with the spatial information between channels in the feature domain of the current block of video data, and this is represented as a set of weighting values). Some techniques normalize the attention map or otherwise process data used to generate the attention map in a manner that requires non-linear operations (e.g., square roots and exponential functions). The example techniques may normalize the attention map in a manner that relies on linear operations, such as scaling or averaging, that are less complex for processing circuitry to perform. In accordance with examples described in this disclosure, the processing circuitry may normalize the attention map based on a size of blocks used for training the neural network in-loop filter (NN-ILF).

In this manner, the example techniques may improve the functionality of the processing circuitry that is configured to implement the NN-ILF. For instance, the example techniques may reduce the complexity, processing time, and/or power needed to normalize the attention map as compared to other techniques that rely on non-linear operations.

In one example, the disclosure describes a method of processing video data, the method comprising: receiving, with a neural network in-loop filter (NN-ILF), a current block of video data of a current picture; and filtering, with the NN-ILF, the current block of video data to generate a filtered current block of video data, wherein filtering the current block of video data comprises: generating, with an attention block of the NN-ILF, an attention map indicative of a correlation between elements of features of the current block of video data; modifying, with the attention block of the NN-ILF, the attention map based on a size of blocks used for training the NN-ILF to generate a modified attention map; generating, with the attention block of NN-ILF, feature data based on the modified attention map; and filtering, with the NN-ILF, the current block of video data based on the feature data to generate the filtered current block of video data.

In one example, the disclosure describes a device for processing video data, the device comprising: one or more memories configured to store the video data; and processing circuitry coupled to the one or more memories, wherein the processing circuitry is configured to: receive, with a neural network in-loop filter (NN-ILF), a current block of video data of a current picture; and filter, with the NN-ILF, the current block of video data to generate a filtered current block of video data, wherein to filter the current block of video data, the processing circuitry is configured to: generate, with an attention block of the NN-ILF, an attention map indicative of a correlation between elements of features of the current block of video data; modify, with the attention block of the NN-ILF, the attention map based on a size of blocks used for training the NN-ILF to generate a modified attention map; generate, with the attention block of NN-ILF, feature data based on the modified attention map; and filter, with the NN-ILF, the current block of video data based on the feature data to generate the filtered current block of video data.

In one example, the disclosure describes one or more computer-readable storage media storing instructions thereon that when executed cause one or more processors to: receive, with a neural network in-loop filter (NN-ILF), a current block of video data of a current picture; and filter, with the NN-ILF, the current block of video data to generate a filtered current block of video data, wherein the instructions that cause the one or more processors to filter the current block of video data comprise instructions that cause the one or more processors to: generate, with an attention block of the NN-ILF, an attention map indicative of a correlation between elements of features of the current block of video data; modify, with the attention block of the NN-ILF, the attention map based on a size of blocks used for training the NN-ILF to generate a modified attention map; generate, with the attention block of NN-ILF, feature data based on the modified attention map; and filter, with the NN-ILF, the current block of video data based on the feature data to generate the filtered current block of video data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram of a hybrid video coding framework.

FIG. 3 is a block diagram illustrating an example video encoder that may perform the techniques of this disclosure.

FIG. 4 is a block diagram illustrating an example video decoder that may perform the techniques of this disclosure.

FIG. 5 is a flowchart illustrating an example method for encoding a current block of video data in accordance with the techniques of this disclosure.

FIG. 6 is a flowchart illustrating an example method for decoding a current block of video data of video data in accordance with the techniques of this disclosure.

FIG. 7 is a conceptual diagram illustrating an example of hierarchical prediction structures with GOP size equal to 16.

FIG. 8 is a conceptual diagram illustrating a convolutional neural network (CNN)-based filter with 4 layers.

FIG. 9 is a conceptual diagram illustrating a CNN-based filter with padded input samples and supplementary data.

FIG. 10 is a conceptual diagram illustrating a CNN architecture.

FIG. 11 is a conceptual diagram illustrating an attention residual block of FIG. 10.

FIG. 12 is a conceptual diagram illustrating a spatial attention layer.

FIG. 13 is a conceptual diagram illustrating an example CNN architecture.

FIG. 14 is a conceptual diagram illustrating an example residual block structure of FIG. 13.

FIG. 15 is a conceptual diagram illustrating an example CNN architecture.

FIG. 16 is a conceptual diagram illustrating an example filter block structure of FIG. 15.

FIG. 17 is a conceptual diagram illustrating an example CNN architecture.

FIG. 18 is a conceptual diagram illustrating an example multiscale feature extraction backbone network with two-component convolution.

FIG. 19 is a conceptual diagram illustrating an example unified filter with joint model (joint luma and chroma).

FIG. 20 is a conceptual diagram illustrating an example unified filter with separate luma/chroma models (luma).

FIG. 21 is a conceptual diagram illustrating an example unified filter with separate luma/chroma models (chroma).

FIG. 22 is a conceptual diagram illustrating a unified filter with luma/chroma split.

FIG. 23 is a conceptual diagram illustrating an example of backbone residue block, type 1.

FIG. 24 is a conceptual diagram illustrating an example of backbone residue block, type 2.

FIG. 25 is a conceptual diagram illustrating an example of backbone residue block, type 3.

FIG. 26 is a conceptual diagram illustrating an example of backbone residue block, type 4.

FIG. 27 is a conceptual diagram illustrating an example of switched order decompositions (Type 1 and Type 2) integrated into a unified filter architecture (luma filtering).

FIG. 28 is a conceptual diagram of a high-level overview of a transformer module.

FIG. 29 is a conceptual diagram illustrating an example of transformer block for residual network (ResNet) architecture.

FIG. 30 is a conceptual diagram illustrating an example of placing a transformer block inside the ResNet architecture.

FIG. 31 is a conceptual diagram of a high-level overview of the attention only module.

FIG. 32 is a conceptual diagram illustrating an example of the architecture for the attentional block.

FIG. 33 is a conceptual diagram illustrating an example for placing the attention block at the end of the backbone block inside the ResNet architecture.

FIG. 34 is a conceptual diagram illustrating an example of placing the LCA (low complexity attention block) at the multi-scale branch in the in-loop filtering (ILF) architecture.

FIG. 35 is a conceptual diagram illustrating an example of placing the LCA outside of the residual backbone network in ILF architecture.

FIG. 36 is a conceptual diagram illustrating an example of integration of LCA in ILF architecture.

FIG. 37 is a flowchart illustrating an example method of processing video data.

FIG. 38 is a flowchart illustrating an example method of processing video data.

### DETAILED DESCRIPTION

A convolutional Neural Network (CNN) based filter with residual network (ResNet) architecture which utilizes cascaded number of backbone blocks (e.g., sequential backbone blocks) may be an appropriate as part of an in-loop filtering architecture for video data. To improve performance of such a filter, a transformer self-attention mechanism may be utilized to capture distant, non-local relevance in an image. A transformer block may involve operators that are non-hardware friendly. Accordingly, an attention block is derived from the transformer block to improve and accelerate the filtering. However, the attention map generated in the attention block may be unnormalized in this model and may not be adaptive to block-size changes.

This disclosure describes example techniques and/or algorithms to normalize the attention map during the inference (e.g., during the filtering of a current block of video data). The example techniques described in this disclosure are related to neural network in-loop filters (NN-ILFs), such as CNN-assisted loop filters, however, the techniques may be applicable to any cascaded CNN-based video coding tool. Methods may be used in the context of advanced video codecs, such as extensions of VVC or the next generation of video coding standards, and any other video codecs.

In some techniques, a transformer block included an attention block and a feedforward network. The attention block included normalization layer(s) and softmax layer(s). Part of the functionality of the normalization layer(s) and the softmax layer(s) is to normalize the attention block so that feature data can be extracted in a common manner regardless of a size of a current block of video data that is being filtered. For instance, different sized current blocks of video data may result in different sized attention maps resulting in a different magnitude of output values after applying the in the output features that are different than a size for which the NN-ILF was trained (e.g., a size of activation values in the output features that are different than a size for which the NN-ILF was trained), which in turn degrades the filtering effectiveness.

With the normalization layer(s) and the softmax layer(s), it may be possible to normalize the attention map so that the size of the activation values in the output features align with the size of training of the NN-ILF. However, normalization layer(s) and softmax layer(s) utilize non-hardware friendly operations, such as square roots and exponential functions, which are examples of non-linear operations. Accordingly, the processing power and/or time of processing circuitry implementing the NN-ILF may be negatively impacted due to the implementation of the normalization layer(s) and softmax layer(s).

Removing the normalization layer(s) and the softmax layer(s) from the attention block may result in a hardware-friendly implementation, but because the attention map is no longer normalized, the filtering of the current block of video data may be less effective. In accordance with one or more examples described in this disclosure, the processing circuitry may be configured to normalize the attention map in a more hardware-friendly manner.

For example, during a training phase, the NN-ILF may be trained using blocks for a particular size. However, during inference (e.g., the filtering of a current block of video data), the current block of video data may have a different size. In one or more examples, the processing circuitry may be configured to modify the attention map based on a size of blocks used for training the NN-ILF to generate a modified attention map. As one example, the processing circuitry may determine a scale factor based on a ratio of a number of samples in the current block of video data and a number of samples in blocks used for training, and scale the attention map based on the scale factor to generate the modified attention map. In some examples, the number of samples in each of the blocks may be fixed (e.g., have the same number of samples), or an average of the number of samples may be used as a number of samples in each of the blocks used for training if the blocks used for training have different number of blocks.

The scale factor may be the ratio of the number of samples in the current block of video data and the number of samples in a block used for training, or the ratio multiplied with a number greater than one. As another example, the processing circuitry may down-sample (e.g., via average pooling) the attention map to match a resolution of the blocks used for training.

In this manner, the processing circuitry may modify the attention map in a hardware-friendly manner for normalization even in situations where the size of the current block of video data is dynamic (e.g., there is no fixed size for the current block of video data). For instance, the processing circuitry may modify the attention map utilizing only liner operations. However, it may be possible for the processing circuitry to modify the attention map utilizing non-linear operations that are nevertheless hardware-friendly such as through the use of lookup tables (LUTs) or other such techniques.

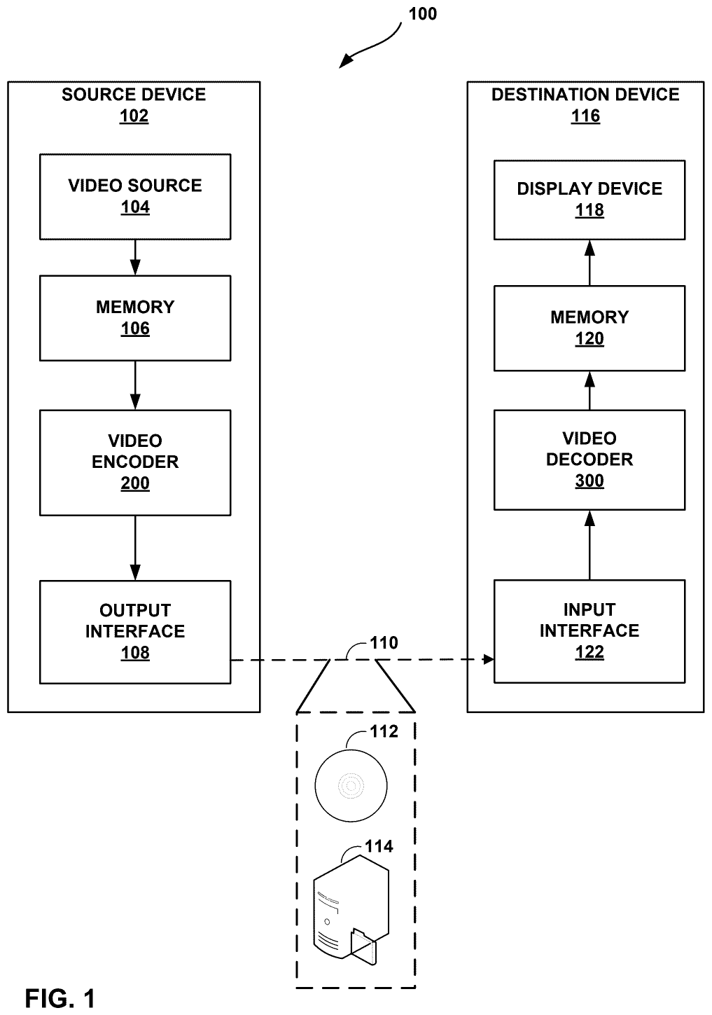

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for neural network-based in-loop filtering. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for neural network based in-loop filtering. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). A draft of the VVC standard is described in Bross, et al. “Versatile Video Coding (Draft 10),” Joint Video Experts Team (JVET) of ITU-T SG 16 WP 3 and ISO/IEC JTC 1/SC 29/WG 11, 18^{th} Meeting: by teleconference, 22 Jun.-1 Jul. 2020, JVET-S2001-vA (hereinafter “VVC Draft 10”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile.

The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block of video data (e.g., a block of a CU) from which to predict samples of the current block of video data. Such samples may generally be above, above and to the left, or to the left of the current block of video data in the same picture as the current block of video data, assuming video encoder 200 codes CTUs and CUs in raster scan order (left to right, top to bottom).

Video encoder 200 encodes data representing the prediction mode for a current block of video data. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

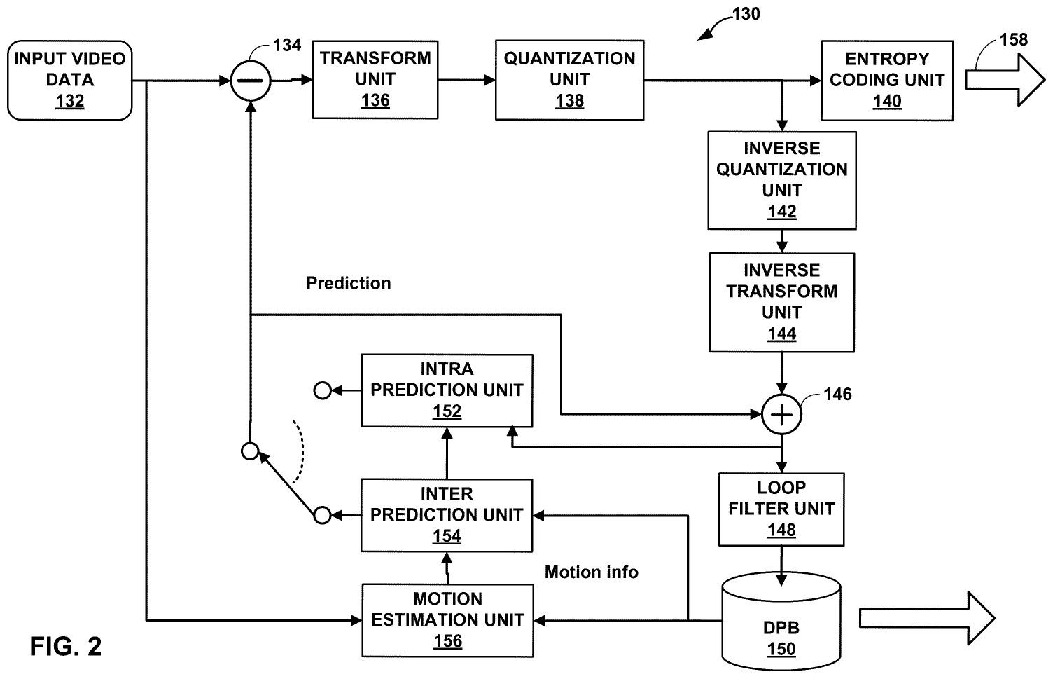

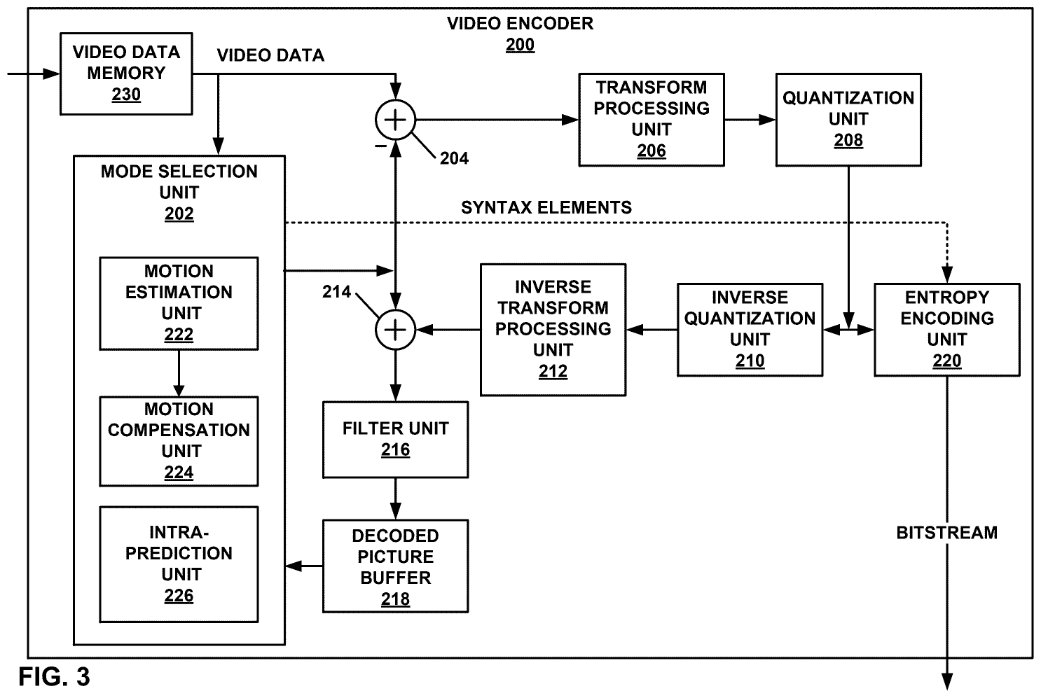

All video coding standards since H.261 have been based on the so-called hybrid video coding principle, which is illustrated in FIGS. 2 and 3. The term hybrid refers to the combination of two means to reduce redundancy in the video signal, i.e., prediction and transform coding with quantization of the prediction residual. Whereas prediction and transforms reduce redundancy in the video signal by decorrelation, quantization decreases the data of the transform coefficient representation by reducing their precision, ideally by removing only irrelevant details. This hybrid video coding design principle is also used in the two most recent standards HEVC and VVC. As shown in FIG. 2, a modern hybrid video coder is composed for various building blocks.

FIG. 2 is a conceptual diagram illustrating a hybrid video coding framework. As shown in FIG. 2, a modern hybrid video coder 130 generally performs block partitioning, motion-compensated or inter-picture prediction, intra-picture prediction, transformation, quantization, entropy coding, and/or post/in-loop filtering. In the example of FIG. 2, video coder 130 includes summation unit 134, transform unit 136, quantization unit 138, entropy coding unit 140, inverse quantization unit 142, inverse transform unit 144, summation unit 146, loop filter unit 148, decoded picture buffer (DPB) 150, intra prediction unit 152, inter-prediction unit 154, and motion estimation unit 156.

In general, video coder 130 may, when encoding video data, receive input video data 132. Block partitioning is used to divide a received picture (image) of the video data into smaller blocks for operation of the prediction and transform processes. Early video coding standards used a fixed block size, typically 16×16 samples. Recent standards, such as HEVC and VVC, employ tree-based partitioning structures to provide flexible partitioning.

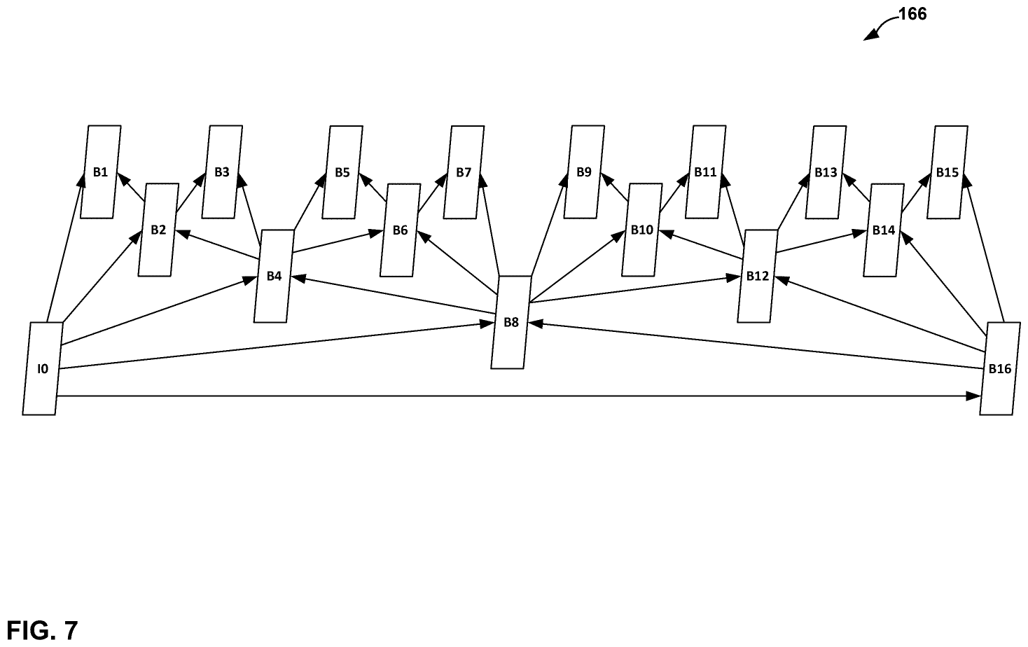

Motion estimation unit 156 and inter-prediction unit 154 may predict input video data 132, e.g., from previously decoded data of DPB 150. Motion-compensated or inter-picture prediction takes advantage of the redundancy that exists between (hence “inter”) pictures of a video sequence. According to block-based motion compensation, which is used in the modern video codecs, the prediction is obtained from one or more previously decoded pictures, e.g., the reference picture(s). The corresponding areas to generate the inter-prediction are indicated by motion information, including motion vectors and reference picture indices. In recent video codecs, hierarchical prediction structures inside a group of pictures (GOP) is applied to improve coding efficiency. FIG. 7 is a conceptual diagram illustrating an example of hierarchical prediction structures 166 with GOP size equal to 16.

Summation unit 134 may calculate residual data as differences between input video data 132 and predicted data from intra prediction unit 152 or inter-prediction unit 154. Summation unit 134 provides residual blocks to transform unit 136, which applies one or more transforms to the residual block to generate transform blocks. Quantization unit 138 quantizes the transform blocks to form quantized transform coefficients. Entropy coding unit 140 entropy encodes the quantized transform coefficients, as well as other syntax elements, such as motion information or intra-prediction information, to generate output bitstream 158.

Meanwhile, inverse quantization unit 142 inverse quantizes the quantized transform coefficients, and inverse transform unit 144 inverse transforms the transform coefficients, to reproduce residual blocks. Summation unit 146 combines the residual blocks with prediction blocks (on a sample-by-sample basis) to produce decoded blocks of video data. Loop filter unit 148 applies one or more filters (e.g., at least one of a neural network-based filter, a neural network-based loop filter, a neural network-based post loop filter, an adaptive in-loop filter, or a pre-defined adaptive in-loop filter) to the decoded block to produce filtered decoded blocks.

A block of video data, such as a CTU or CU, may in fact include multiple color components, e.g., a luminance or “luma” component, a blue hue chrominance or “chroma” component, and a red hue chrominance (chroma) component. The luma component may have a larger spatial resolution than the chroma components, and one of the chroma components may have a larger spatial resolution than the other chroma component. Alternatively, the luma component may have a larger spatial resolution than the chroma components, and the two chroma components may have equal spatial resolutions with each other. For example, in 4:2:2 format, the luma component may be twice as large as the chroma components horizontally and equal to the chroma components vertically. As another example, in 4:2:0 format, the luma component may be twice as large as the chroma components horizontally and vertically. The various operations discussed above may generally be applied to each of the luma and chroma components individually (although certain coding information, such as motion information or intra-prediction direction, may be determined for the luma component and inherited by the corresponding chroma components).

Intra-picture prediction exploits spatial redundancy that exists within a picture (hence “intra”) by deriving the prediction for a block from already coded/decoded, spatially neighboring (reference) samples. The directional angular prediction, DC prediction and plane or planar prediction are used in the most recent video codec, including AVC, HEVC, and VVC.

Hybrid video coding standards apply a block transform to the prediction residual (regardless of whether it comes from inter- or intra-picture prediction). In early standards, including H.261, H.262, and H.263, a discrete cosine transform (DCT) is employed. In HEVC and VVC, more transform kernels besides DCT may be applied, in order to account for different statistics in the specific video signal.

Quantization aims to reduce the precision of an input value or a set of input values in order to decrease the amount of data needed to represent the values. In hybrid video coding, quantization is typically applied to individual transformed residual samples, i.e., to transform coefficients, resulting in integer coefficient levels. In recent video coding standards, the step size is derived from a so-called quantization parameter (QP) that controls the fidelity and bit rate. A larger step size lowers the bit rate but also deteriorates the quality, which e.g., results in video pictures exhibiting blocking artifacts and blurred details.

Entropy coding unit 140 may perform context-adaptive binary arithmetic coding (CABAC) on encoded video. CABAC is used in recent video codecs, e.g. AVC, HEVC and VVC, due to its high efficiency.

Filtering unit 148 may perform post-loop or in-loop filtering. Post/In-Loop filtering is a filtering process (or combination of such processes) that is applied to the reconstructed picture to reduce the coding artifacts. The input of the filtering process is generally the reconstructed picture (or reconstructed block of a picture), which is the combination of the reconstructed residual signal (e.g., the reconstruction samples), where the reconstruction samples include quantization error, and the prediction (e.g., the prediction samples). As shown in FIG. 2, the reconstructed pictures after in-loop filtering are stored in decoded picture buffer (DPB) 150 and are used as a reference for inter-picture prediction of subsequent pictures. Filtering unit 148 may apply in-loop filtering according to the techniques of this disclosure.

The coding artifacts are mostly determined by the QP (quantization parameter), therefore QP information is generally used in design of the filtering process. In HEVC, the in-loop filters include deblocking filtering and sample adaptive offset (SAO) filtering. In the VVC standard, an adaptive loop filter (ALF) was introduced as a third filter. The filtering process of ALF is as shown below:

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7 ) \qquad ( 1 )$$

where can R(i,j) is the samples before filtering process, R′(i,j) is the sample value after filtering process. f(k,l) denotes the filter coefficients, K(x,y) is the clipping function and c(k,l) denotes the clipping parameters. The variable k and l varies between

$$- \frac{L}{2} and \frac{L}{2}$$

where L denotes the filter length. The clipping function K(x,y)=min(y,max(−y,x)) which corresponds to the function Clip3 (−y,y,x). The clipping operation introduces non-linearity to make ALF more efficient by reducing the impact of neighbor sample values that are too different with the current sample value. In VVC, the filtering parameters can be signalled in the bit stream, it can be selected from the pre-defined filter sets. The ALF filtering process can also be summarised as following equation.

$${R}^{′} ( i , j ) = R ( i , j ) + ALF\_residual \_ouput ( R ) \qquad ( 2 )$$

The following describes neural network (NN) based filtering for video coding. Many works show that embedding neural networks into a hybrid video coding framework can improve compression efficiency. Neural networks have been used for intra prediction and inter prediction to improve the prediction efficiency. Neural network (NN)-based in-loop filtering is also a prominent research topic in recent years. In some works, the filtering process is applied as a post-filter. In this case, the filtering process is only applied to the output picture and the unfiltered picture is used as reference picture.

The NN-based filter can be applied additionally to the existing filters such as deblocking filter, SAO and ALF. The NN-based filter can also be applied exclusively, where it is designed to replace all the existing filters.

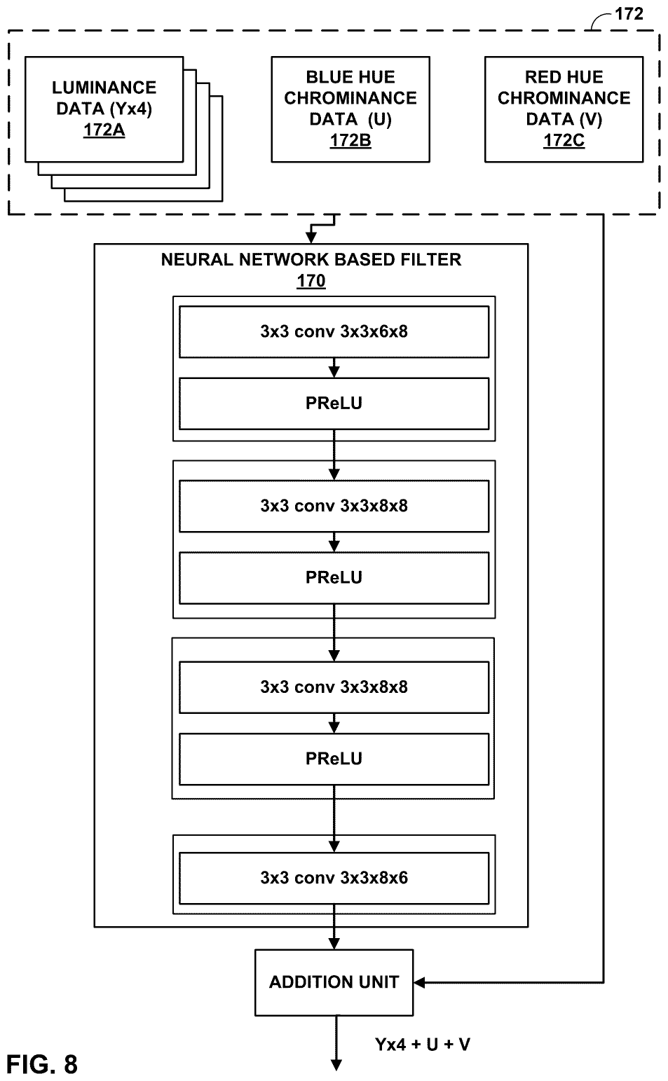

An example of an NN-based filter is shown in FIG. 8. FIG. 8 is a conceptual diagram illustrating a CNN-based filter with 4 layers. The NN-based filtering process take the reconstructed Luma and chroma samples, packed in a 3D volume with 6 planes, as inputs, and the intermediate outputs are residual samples, which are added back to the input to refine the input samples. The NN-based filter may use all color components as input to exploit the cross-component correlations. The different components may share the same filters (including network structure and model parameters) or each component may have its own specific filters.

For instance, NN-based filter 170 can be applied in addition to the existing filters, such as deblocking filters, sample adaptive offset (SAO), and/or adaptive loop filtering (ALF). NN-based filters can also be applied exclusively, where NN-based filters are designed to replace all of the existing filters. Additionally, or alternatively, NN-based filters, such as NN-based filter 170, may be designed to supplement, enhance, or replace any or all of the other filters.

The NN-based filtering process of FIG. 8 may take the reconstructed samples (e.g., luma and chroma samples which, in some examples, may be packed in a 3D volume with 6 planes) as inputs, and the intermediate outputs are residual samples, which are added back to the input to refine the input samples. The NN-based filter may use all color components (e.g., Y, U, and V, or Y, Cb, and Cr, e.g., luminance data 172A, blue-hue chrominance 172B, and red-hue chrominance 172C) as inputs 172 to exploit cross-component correlations. Different color components may share the same filter(s) (including network structure and model parameters) or each component may have its own specific filter(s).

The filtering process can also be generalized as follows:

$${R}^{′} ( i , j ) = R ( i , j ) + NN\_filter \_residual \_ouput ( R ) \qquad ( 3 )$$

The model structure and model parameters of NN-based filter(s) can be pre-defined and be stored at video encoder 200 and video decoder 300. The filters can also be signalled in the bit stream.

In the example of FIG. 8, the NN-based filter 170 may include a series of feature extraction layers, followed by an output convolution. In FIG. 8, the feature extraction layers may include a 3×3 convolution (conv) layer followed by a parametric rectified linear unit (PReLU) layer. The convolution layer applies a convolution operation to the input data, which involves a filter or kernel sliding over the input data (e.g., the reconstruction samples of input 172) and computing dot products at each position. The convolution operation essentially captures local patterns within the input data. For example, in the context of image processing, these patterns could be edges, textures, or other visual features. The filter or kernel is a small matrix of weights that gets updated during the training process. By sliding this filter across the input data (or feature map from a previous layer) and computing the dot product at each position, the convolution layer creates a feature map that encodes spatial hierarchies and patterns detected in the input.

The output of a convolution layer is a set of feature maps, each corresponding to one filter, capturing different aspects of the input data. This layer helps the neural network to learn increasingly complex and abstract features as the data passes through deeper layers of the network. The first 3×3 in the nomenclature 3×3 conv 3×3×6×8 in FIG. 8 indicates that the convolution layer has a 3×3 filter size (e.g., a 3×3 matrix). 3×3×6×8 refers to both the input and output dimensions of the convolution layer, where 6 is the number of input channels, and 8 is the number of output channels.

The PRELU layer is an activation function used in neural networks, and was introduced as a variant of the ReLU (Rectified Linear Unit) activation function. As described above, the convolution layer outputs feature maps (also called feature data), each corresponding to one filter, representing detected features in the input. Following the convolution layer, the PRELU layer applies the PRELU activation function to each element of the feature maps produced by the convolution layer. For positive values, the PRELU layer acts like a standard ReLU, passing the value through. For negative values, instead of setting the negative values to zero (e.g., as ReLU does), the PRELU layer allows a small, linear, negative output. This keeps the neurons active and maintains the gradient flow, which can be beneficial for learning in deep networks.

In summary, when a convolution layer is followed by a PRELU layer, the convolution layer first extracts features from the input data through a set of learned filters. The resulting feature maps (e.g., feature data) are then passed through the PRELU activation function, which introduces non-linearity and helps to avoid the problem of dying neurons by allowing a small gradient when the inputs are negative. This combination is effective in learning complex patterns in the data while maintaining robust gradient flow, especially beneficial in deeper network architectures.

When NN-based filtering is applied in video coding, the whole video signal (pixel data) might be split into multiple processing units (e.g. 2D blocks), and each processing unit can be processed separately or be combined with other information associated with the current block of pixels. The possible choices of processing unit include a frame, a slice/tile, a CTU or any pre-defined or signaled shapes and sizes.

To further improve the performance of NN-based filtering, different types of input data can be processed jointly to produce the filtered output. Input data may include, but not limited to, reconstructed, prediction pixels, pixels after the loop filter(s), partitioning structure information, deblocking parameters (boundary strength (BS)), quantization parameter (QP) values, slice or picture types or filters applicability or coding modes map. Input data can be provided at the different granularity. Luma reconstruction and prediction samples could be provided at the original resolution, whereas chroma samples could be provided at lower resolution, e.g., for 4:2:0 representation, or can be up-sampled to the Luma resolution to achieve per-pixel representation. Similarly, QP, BS, partitioning or coding mode information can be provided at lower resolution, including cases with a single value per frame/slice or processing block (e.g., QP), or this value can be expanded (replicated) to achieve per-pixel representation.

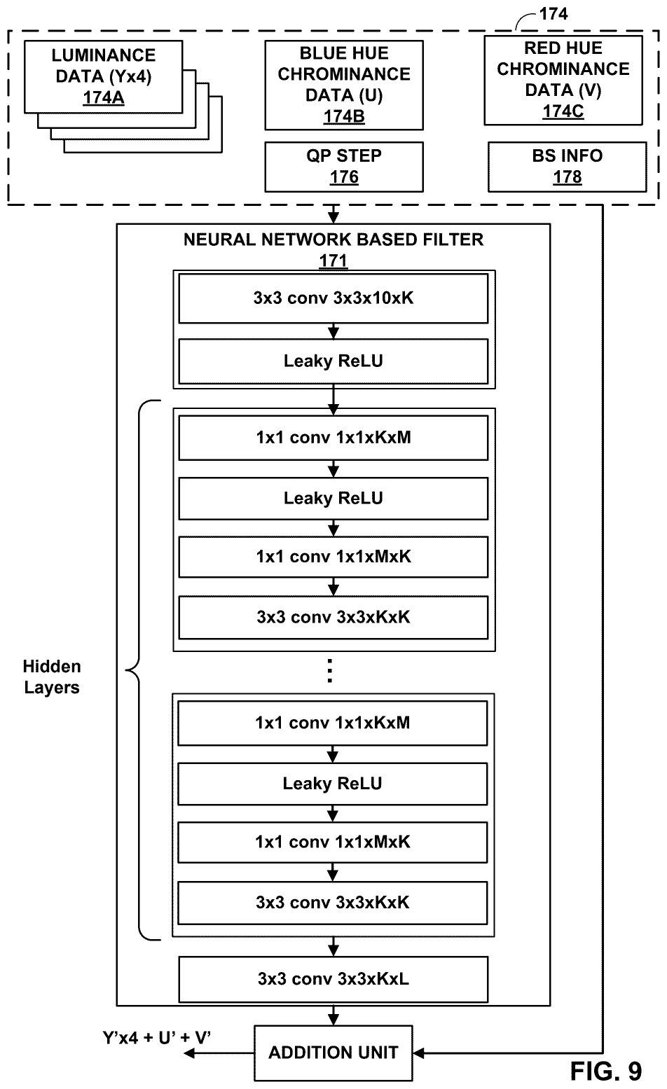

An example of an architecture utilizing supplementary data was proposed in Wang et al “EE1-1.4: Test on Neural Network-based In-Loop Filter with Large Activation Layer,” JVET-V0115, April 2021 (hereinafter, JVET-V0115) and shown in FIG. 9. FIG. 9 is a conceptual diagram illustrating a CNN-based filter with padded input samples and supplementary data. Pixels of the processing block (4 subblocks of interlaced Luma samples plane and associated Cb and Cr planes) are combined with supplementary information such as QP steps and BS. The area of the processing pixel is extended with 4 padded pixels from each side. The total size of the processing volume is (4+64+4)×(4+64+4)×(4 Y+2UV+1QP+3BS).

For example, NN-based filter 171 uses pixels/samples of the processing block combined with supplementary data as input 174. The input 174 may include 4 subblocks of interlaced luma samples (Yx4) 174A and associated blue hue chrominance (U) data 174B and red hue chrominance (V) data 174C. The supplementary data includes a quantization parameter (QP) step 176 and a boundary strength (BS) 178. The area of the input pixels/samples may be extended with 4 padded pixels/samples from each side. The resulting dimensions of the processing volume is (4+64+4)×(4+64+4)×(4 Y+2UV+1QP+3BS).

Relative to the NN-based filter in FIG. 8, NN-based filter 171 may include two or more hidden layers that utilize both 1×1 convolutions and a Leaky ReLU layer. A leaky ReLU layer. Similar to a PRELU layer, a Leaky ReLU layer allows a small, non-zero gradient to be output when the layer is not active. Instead of outputting zero for negative inputs, the Leaky ReLU multiplies these inputs by a small constant. This small slope ensures that even neurons that would otherwise be inactive still contribute a small amount to the network's learning, reducing the likelihood of the dying ReLU problem.

Video encoder 200 and video decoder 300 may be configured to perform NN-based filtering with multi-mode design. To further improve the performance of NN based filtering, multi-mode solutions can be designed. For example, for each processing unit, encoder may select among a set of modes based on rate-distortion optimization and the choice can be signaled in the bit-stream, the different modes may include different NN models, different values that used as the input information of the NN models, etc. As an example, Y. Li et al “EE1-1.7: Combined Test of EE1-1.6 and EE1-1.3,” JVET-Z0113, April 2022 (hereinafter, JVET-Z0113) proposed a NN based filtering solution that created multiple modes based on a single NN model by using different QP values as input of the NN model for different modes.

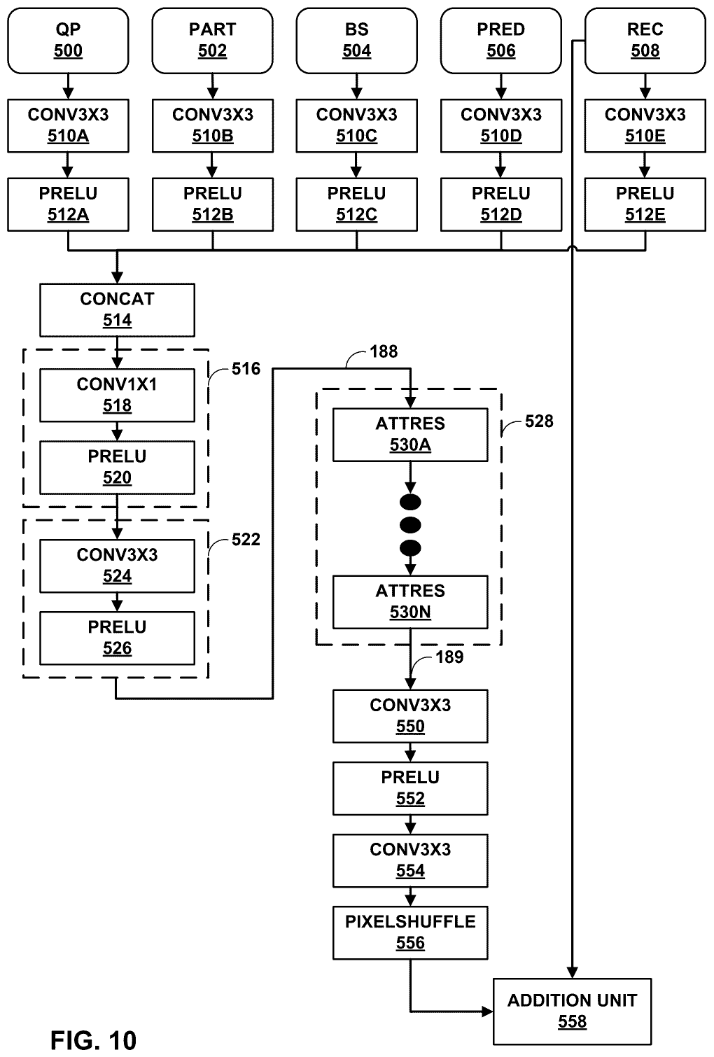

This following section presents examples of CNN In-Loop Filtering (ILF) architecture that are being actively developed in JVET. In JVET-Z0113, an NN based filtering solution with multiple modes was proposed. The structure of the network is shown in FIG. 10. FIG. 10 is a conceptual diagram illustrating a CNN architecture.

In the first part (FIG. 10), the different input data types are convolved with number of kernels size of 3×3 to produce feature maps, undergo activation and results for each data type are concatenated, fused and subsampled once to create the output y. The number of feature maps used in JVET-Z0113 is 96. This output is then fed through N=8 attention residual blocks, each one with the structure shown in FIG. 10. The output from the last attention residual block z is fed into the last part of the network. The ResNet is defined as a network with skip connections that transfer the input signal directly to merge with the output of the network by using addition, and example of the ResNet backbone block is shown in FIG. 10.

For example, the NN-based filter of FIG. 10 includes a first portion including input 3×3 convolutions 510A-510E and respective parametric rectified linear units (PReLUs) 512A-512E for each of the inputs to generate feature maps (e.g., the feature extraction section of the NN-filter). Concatenation unit 514 concatenates the feature maps and provides them to fuse block 516 and transition block 522. While shown as fuse block 516 and transition block 522, in some examples, fuse block 516 and transition block 522 may together be referred to as a fusion block. The NN-based filter in FIG. 10 further includes a set 528 of attention residual (AttRes) blocks 530A-530N; and a last portion (e.g., the tail section) including 3×3 convolution 550, PRELU 552, 3×3 convolution 554, and pixel shuffle unit 556. The AttRes blocks may also be referred to as backbone blocks.

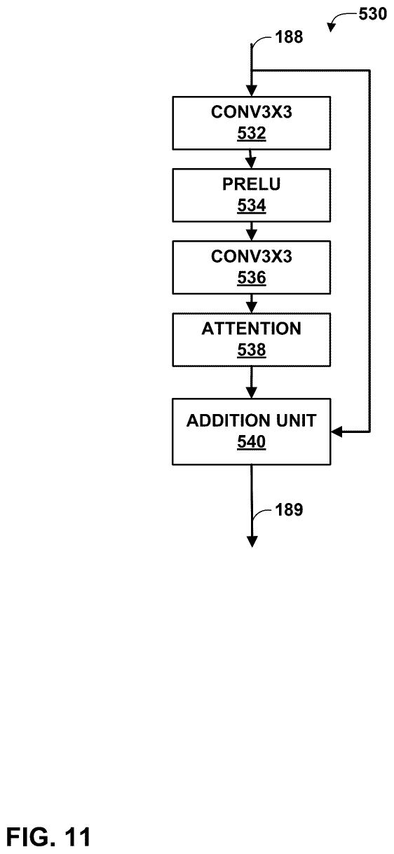

In the first portion (e.g., the feature extraction section), different inputs, including quantization parameter (QP) 500, partition information (part) 502, boundary strength (BS) 504, prediction samples (pred) 506, and reconstruction samples (rec) 508 are received. Respective 3×3 convolutions 510A-510E and PRELUs 512A-512E convolve and activate the respective inputs to produce feature maps. Concatenation unit 514 then concatenates the feature maps. Fuse block 516, including 1×1 convolution 518 and PRELU 520, fuses the concatenated feature maps. Transition block, including 3×3 convolution 524 and PRELU 526, subsamples the fused inputs to create output 188. Output 188 is then fed through set 528 of attention residual blocks 530A-530N, which may include a various number of attention residual blocks, e.g., 8. The attention block is explained further with respect to FIG. 11. Output 189 from the last of the set 528 of attention residual blocks 530 is fed to the last portion of the NN-based filter. In the last portion, which may be a tail block, 3×3 convolution 550, PRELU 552, 3×3 convolution 554, and pixel shuffle unit 556 processes output 189, and addition unit 558 combines this result with the original input reconstructions samples 508. This ultimately forms the filtered output for presentation and storage as reference for subsequent inter-prediction, e.g., in a decoded picture buffer (DPB). In some examples, the NN-based filter of FIG. 10 uses 96 feature maps.

FIG. 11 is a conceptual diagram illustrating an attention residual block of FIG. 10. That is, FIG. 11 depicts attention residual block 530, which may include components similar to those of attention residual blocks 530A-530N of FIG. 10. In this example, attention residual block 530 includes first 3×3 convolution 532, parametric rectified linear unit (PRELU) filter 534, second 3×3 convolution 536, an attention block 538, and addition unit 540. Addition unit 540 combines the output of attention block 538 and output 188, initially received by convolution 532, to generate output 189.

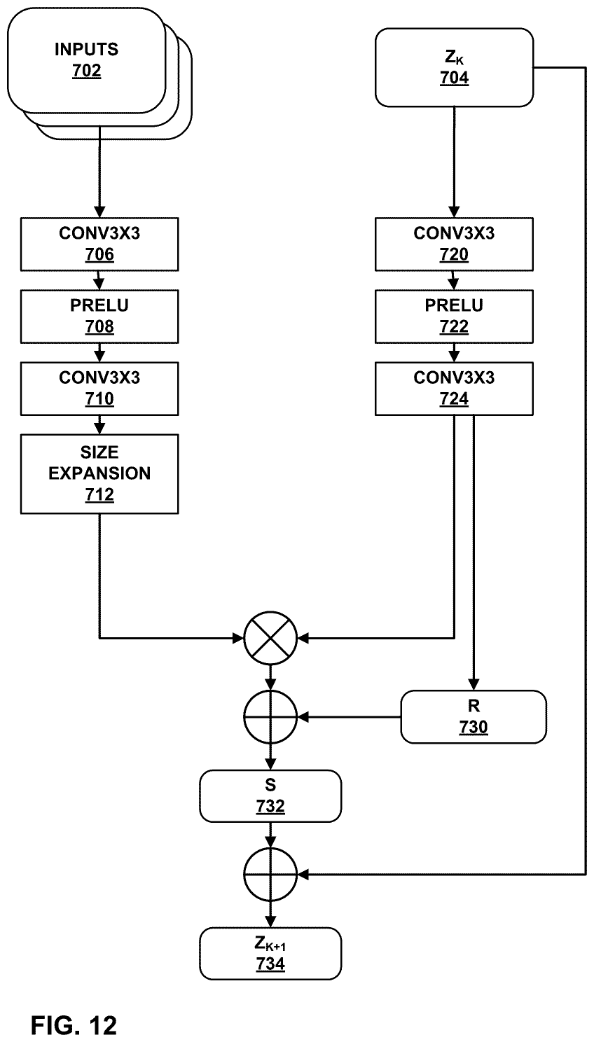

The spatial attention layer in AttRes block is illustrated in FIG. 12 in JVET-Z0113. FIG. 12 is a conceptual diagram illustrating a spatial attention layer. As shown in FIG. 12, a spatial attention layer of attention residual block 530 includes 3×3 convolution 706, PReLU 708, 3×3 convolution 710, size expansion unit 712, 3×3 convolution 720, PRELU 722, and 3×3 convolution 724. 3×3 convolution 706 receives inputs 702, corresponding to quantization parameter (QP) 500, partition information (part) 502, boundary strength (BS) 504, prediction information (pred) 506, and reconstructed samples (rec) 508 of FIG. 10. 3×3 convolution 720 receives Z_{K} 704. The outputs of size expansion unit 712 and 3×3 convolution 724 are combined, and then combined with R value 730 to generate S value 732. S value 732 is then combined with Z_{K} value 704 to generate output Z_{K+1} value 734.

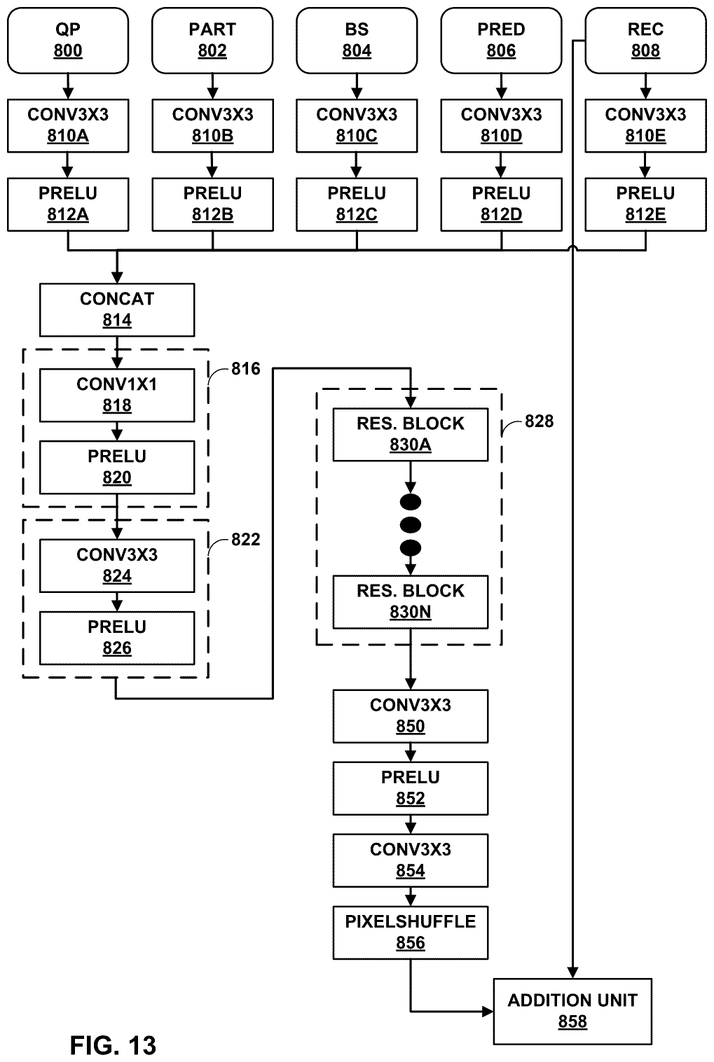

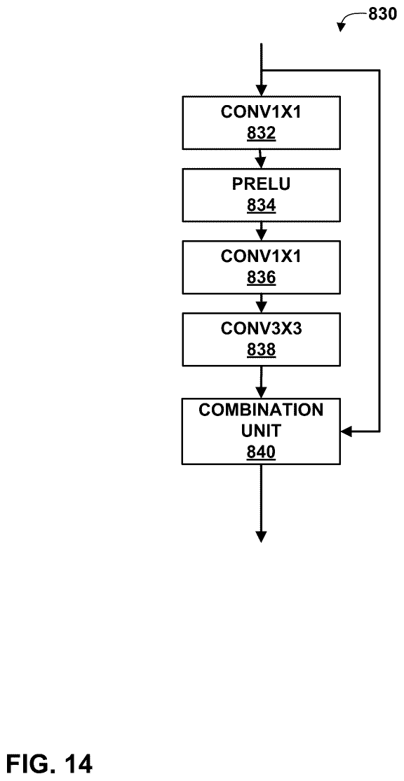

In S. Eadie, M. Coban, M. Karczewicz, EE1-1.9: Reduced complexity CNN-based in-loop filtering, JVET-AC0155, January 2023 (hereinafter, “JVET-AC0155”), an alternative design of NN architecture was proposed. It was proposed to use a larger number of low complexity residual blocks in the backbone of the JVET-Z0113 CNN filter along with a reduced number of channels (feature maps) and removal of the attention modules. The proposed CNN filtering structure (for Luma filtering) is shown in FIG. 13. FIG. 13 is a conceptual diagram illustrating an example CNN-architecture. FIG. 14 shows the CNN architecture of JVET-AC0155 for a filter block.

FIG. 13 is a block diagram illustrating an example of a simplified CNN-based filter architecture. The NN-based filter of FIG. 13 includes 3×3 convolutions 810A-810E and PReLUs 812A-812E, which convolve corresponding inputs, i.e., QP 800, Part 802, BS 804, Pred 806, and Rec 808 to generate feature maps (e.g. the feature extraction section). Concatenation unit 814 concatenates the convolved inputs (e.g., the feature maps). Fuse block 816 then fuses the concatenated feature maps using 1×1 convolution 818 and PRELU 820. Transition block 822 then processes the fused data using 3×3 convolution 824 and PRELU 826. While shown as fuse block 816 and transition block 822, in some examples, fuse block 816 and transition block 822 may together be referred to as a fusion block.

In this example, the NN-based filter includes a set 828 of residual blocks 830A-830N (also called backbone blocks), each of which may be structured according to residual block structure 830 of FIG. 14, as discussed below. Residual blocks 830A-830N may replace AttRes blocks 530A-530N of FIG. 10. The example of FIG. 13 may be used for luminance (luma) filtering, although as discussed below, similar modifications may be made for chrominance (chroma) filtering.

The number of residual blocks and channels included in set 828 of FIG. 13 can be configured differently. That is, N may be set to a different value, and the number of channels in residual block structure 830 may be set to a number different than 160, to achieve different performance-complexity tradeoffs. Chroma filtering may be performed with these modifications for processing of chroma channels.

Set 828 of residual blocks 830A-830N has N instances of residual block structure 830. In one example, N may be equal to 32, such that there are 32 residual block structures. Residual blocks 830A-830N may use 64 feature maps, which is reduced relative to the 96 feature maps used in the example of FIG. 10.

In the last portion of FIG. 13, 3×3 convolution 850, PRELU 852, 3×3 convolution 854, and pixel shuffle unit 856 processes output of set 828, and addition unit 858 combines this result with the original input reconstructions samples (REC) 808. This ultimately forms the filtered output for presentation and storage as reference for subsequent inter-prediction, e.g., in a decoded picture buffer (DPB).

The quantity of residual blocks used is M=24. The quantity of feature maps (convolutions) is reduced to 64. In the ResBlocks, the quantity of channels increases to 160 before the activation layer, and then decreases down to 64 after the activation layer. The number of residual blocks and channels can be configured differently (M set to another value and the number of channels in the residual block can be set to a number different than 160) for different performance-complexity trade-offs. Chroma filtering follows the concept in JVET-Z0113 (e.g., of FIG. 10) with the above modifications to its backbone for processing of chroma channels.

FIG. 14 is a conceptual diagram illustrating an example residual block structure 830 of FIG. 13. In this example, residual block structure 830 includes first 1×1 convolution 832, which may increase a number of input channels to 160, before an activation layer (PRELU 834) processes the input channels. PRELU 834 may thereby reduce the number of channels to 64 through this processing. Second 1×1 convolution 836 then processes the reduced channels, followed by 3×3 convolution 838. Finally, combination unit 840 may combine the output of 3×3 convolution 838 with the original input received by residual block structure 830.

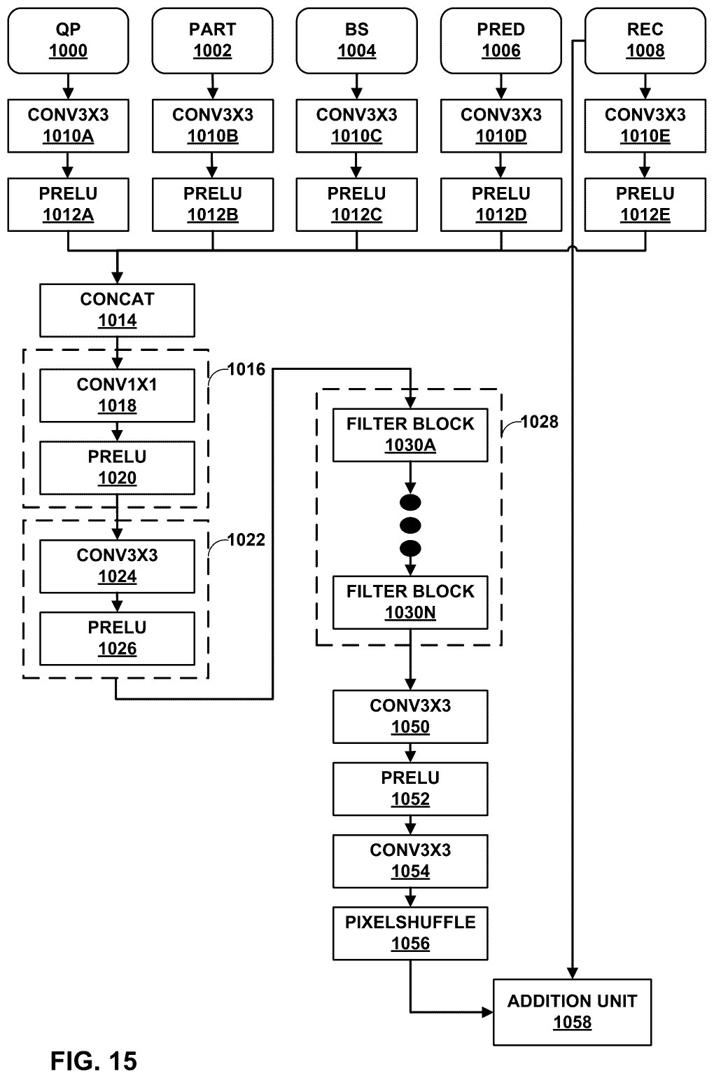

In a further modification, the bypass branch around convolution and activation layers in the residual block in the previous solution is removed, as shown in FIG. 15. The number of channels and number of filter blocks can be configurable, for example, 64 channels, 24 filter blocks, with 160 channels before and after the activation, which results in a complexity of the network of 605.93kMAC and a number of parameters of 1.5M for the intra luma model.

Further complexity reduction of CCN ILF architecture is achieved with utilization of the separable convolution in place of 2D convolutions (3×3). In Seregin et al., “EE2: Summary report of exploration experiment on enhanced compression beyond VVC capability” JVET-AD0023, (hereinafter, “JVET-AD0023”), EE1 test 1.3.5, a low-rank convolution approximation decomposes a 3×3×M×N convolution into a pixel-wise convolution (1×1×M×R), two separable convolutions (3×1×R×R, 1×3×R×R) and another pixel-wise convolution (1×1×R×N) was applied to the residual block of the architecture described in JVET-AC0155. Here, R is the rank of the approximation, and can ablate the performance/complexity of the approximation.

FIG. 15 is a conceptual diagram illustrating another example filtering block structure that may be substituted for the set of attention residual blocks of FIG. 10 according to the techniques of this disclosure. The NN-based filter of FIG. 15 includes 3×3 convolutions 1010A-1010E and PRELUs 1012A-1012E, which convolve respective inputs, i.e., QP 1000, Part 1002, BS 1004, Pred 1006, and Rec 1008 to form feature maps (e.g., the feature extraction section). Concatenation unit 1014 concatenates the feature maps. Fuse block 1016 then fuses the concatenated inputs using 1×1 convolution 1018 and PRELU 1020. Transition block 1022 then processes the fused data using 3×3 convolution 1024 and PRELU 1026. While shown as fuse block 1016 and transition block 1022, in some examples, fuse block 1016 and transition block 1022 may together be referred to as a fusion block.

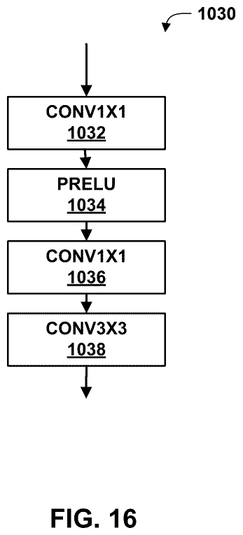

In this example, the NN-based filtering unit includes a set 1028 of N filter blocks 1030A-1030N (also called backbone blocks), each of which may have the structure of filter block 1030 of FIG. 16 as discussed below. Filter block structure 1030 may be substantially similar to residual block structure 830, except that combination unit 840 is omitted from filter block structure 1030, such that input is not combined with output. Instead, output of each residual block structure may be fed directly to the subsequent block.

In the last portion of FIG. 15, 3×3 convolution 1050, PRELU 1052, 3×3 convolution 1054, and pixel shuffle unit 1056 processes output of set 1028, and addition unit 1058 combines this result with the original input reconstructions samples (REC) 1008. This ultimately forms the filtered output for presentation and storage as reference for subsequent inter-prediction, e.g., in a decoded picture buffer (DPB).

FIG. 16 is a conceptual diagram illustrating an example filter block structure 1030 of FIG. 15. In this example, filter block structure 1030 includes first 1×1 convolution 1032, which may increase a number of input channels to 160, before an activation layer (PReLU 1034) processes the input channels. PRELU 1034 may thereby reduce the number of channels to 64 through this processing. Second 1×1 convolution 1036 then processes the reduced channels, followed by 3×3 convolution 1038. As discussed above, filter block structure 1030 does not include a combination unit, in contrast with the residual block structure 830 of FIG. 14.

In one example, the architecture of FIG. 15, with decomposition illustrated in FIG. 16, is implemented with parameters K=64, M=160 and R=51, and total number of 24 residual blocks results in a complexity of the network of 356.43kMAC and a number of parameters of 1.07M for the intra luma model.

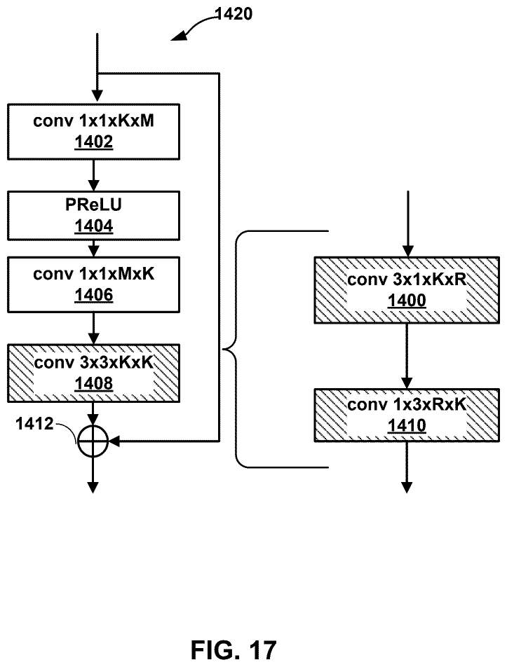

FIG. 17 is a block diagram illustrating an example multiscale feature extraction backbone network with two-component convolution. The example of FIG. 17 may use of an approximation of a 3×3×K×K convolution with a 3×1×K×R convolution and a 1×3×R×K convolution.

In the example of FIG. 17, residual block 1420 includes a 1×1×K×M convolution 1402, followed by PReLU 1404. The output of PRELU 1404 is input to 1×1×M×K convolution 1406. A 3×3×K×K convolution 1408 of residual block 1420 is approximated by a 3×1×K×R convolution 1400 and then a 1×3×R×K convolution 1410. The output of 1×3×R×K convolution 1410 may be input to combination unit 1412 which may combine the output of 1×3×R×K convolution 1410 with an input to 1×1×K×M convolution 1402. R is the canonical rank of the decomposition. A lower rank implies a larger complexity reduction.

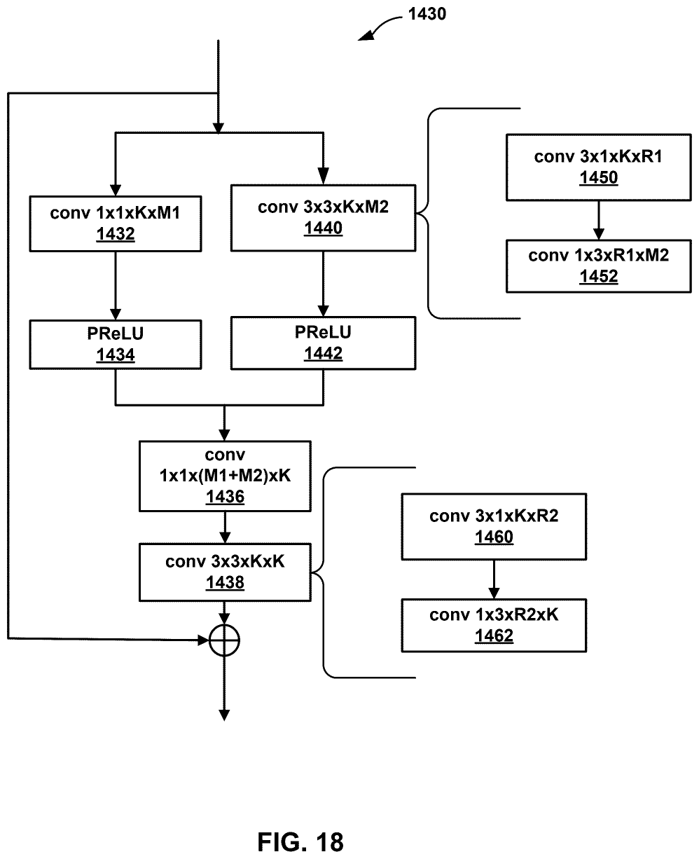

A multiscale feature extraction with a two-component convolution network is proposed in Y. Li, S. Eadie, D. Rusanovskyy, M. Karczewicz, EE1-Related: Combination test of EE1-1.3.5 and multi-scale component of EE1-1.6, JVET-AD0211, April 2023 (hereinafter, “JVET-AD0211”), which is illustrated in FIG. 18, the 3×3 convolutions are decomposed into a 3×1×C1×R convolution and followed by a 1×3×R×C2 convolution, where C1 and C2 are the number of input and output channels, respectively, and R is the rank of the approximation. The parameter R can be made proportional to R=C1×C2/(C1+C2) and controls the complexity of the approximation.

FIG. 18 is a conceptual diagram illustrating an example multiscale feature extraction backbone network with two-component convolution. FIG. 18 shows an architecture with 3×3 convolution blocks being replaced by separable convolutions of 3×1 and 1×3. In this example, residual block structure 1430 includes first 1×1 convolution 1432 before a first activation layer (PReLU 1434) and, in parallel with the first 1×1 convolution 1432 and PRELU 1434, a 3×3 convolution 1440 and a second activation layer (PRELU 1442). A second 1×1 convolution 1436 then processes the combined output of PRELU 1434 and PRELU 1442, followed by 3×3 convolution 1438. In the example of FIG. 18, however, 3×3 convolution 1440 may be approximated using a plurality of separable convolutions, shown as 3×1 convolution 1450 and 1×3 convolution 1452 in FIG. 18. Similarly, 3×3 convolution 1438 may be approximated using a plurality of separable convolutions, shown as 3×1 convolution 1460 and 1×3 convolution 1462 in FIG. 18.

As an example, the architecture illustrated in FIG. 18 can be implemented with parameters R1=8, R2=44, M1=160 and M2=16, and total number of 24 residual blocks, the complexity of the network will be 358.43kMAC and the number of parameters is 1.07M for the intra luma model.

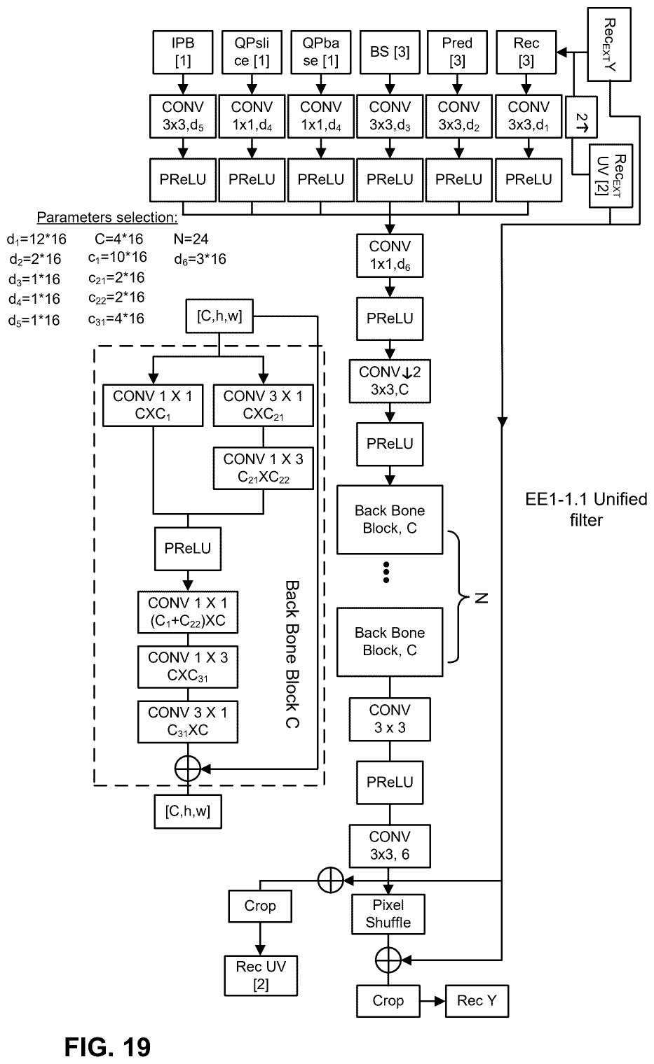

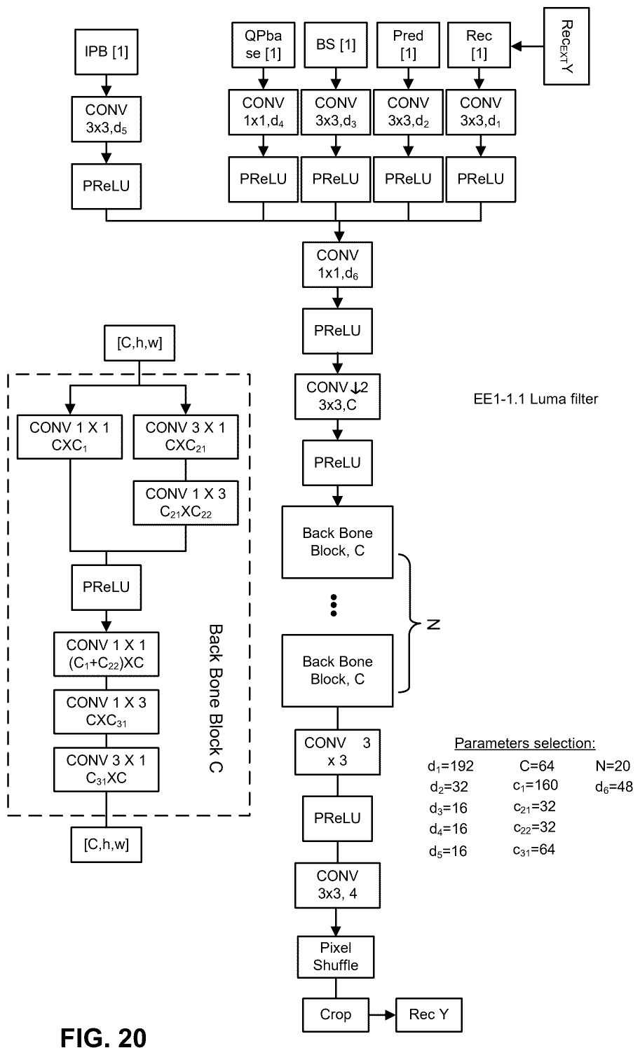

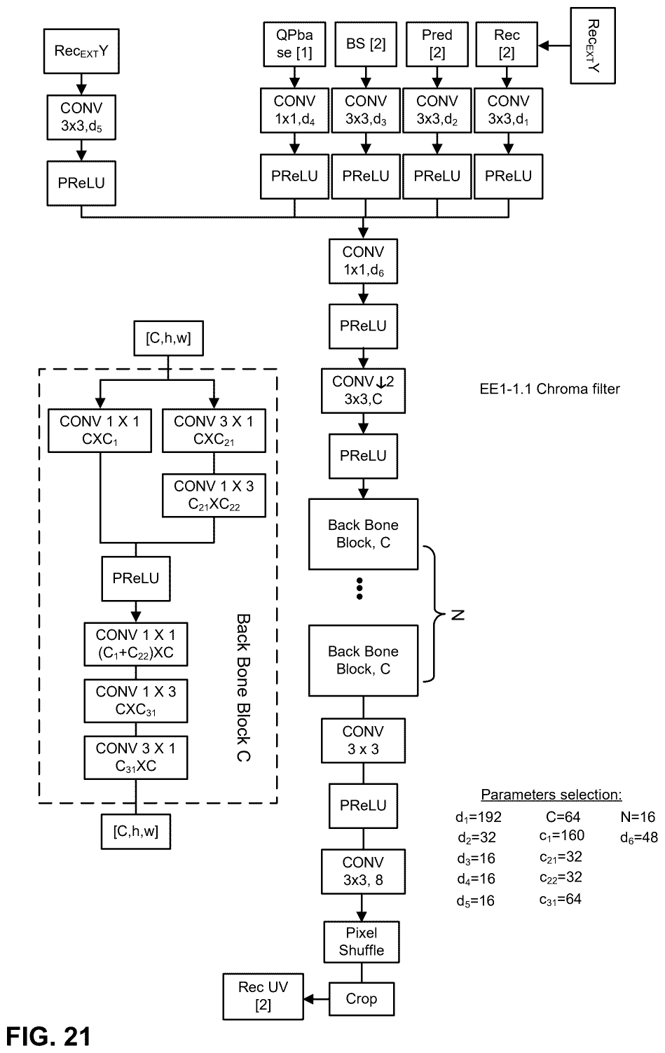

The multiscale feature extraction backbone with the two-component decomposition has been integrated into the unified model in EE. In addition, the specification from the EE contains two versions of the model, which are 1) a unified model for joined luma and chroma, see FIG. 19, and 2) separate models for luma and chroma, respectively, see FIG. 20 and FIG. 21. FIG. 19 is a conceptual diagram illustrating an example unified filter with joint model (joint luma and chroma). FIG. 20 is a conceptual diagram illustrating an example unified filter with separate luma/chroma models (luma). FIG. 21 is a conceptual diagram illustrating an example unified filter with separate luma/chroma models (chroma).

The various components illustrated in FIGS. 19-21 may be similar to other similarly references components above. FIG. 19 illustrates an example where the output is the reconstructed (e.g., filtered) luma and chroma components using the same architecture. FIG. 20 illustrates an example where the output is the reconstructed luma component, and FIG. 21 illustrates an example where the output is the reconstructed chroma components, where the luma and chroma filtering (e.g., reconstruction) is performed separately in FIGS. 20 and 21.

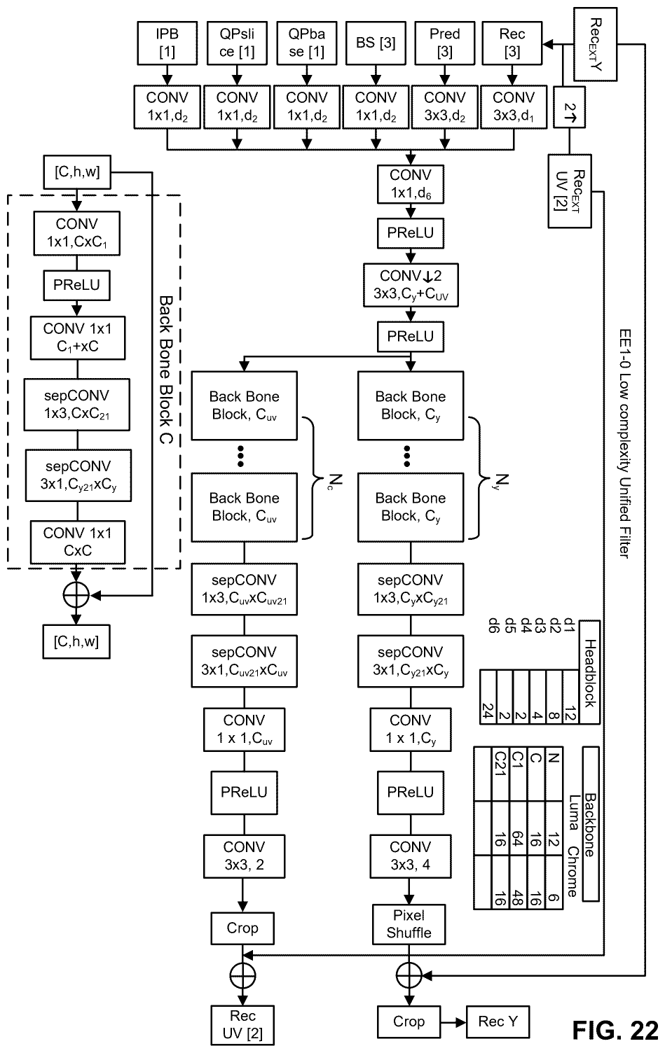

A CCN ILF filter architecture with luma/chroma split was proposed in Rusanovskyy et al., “Unified LOP filter design, training procedure and filter usage” JVET-AE0281, (hereinafter, “JVET-AE0281”). Separate processing branches for luma and chroma allows independent training of the NN weights to target each component and a degree of complexity-performance tradeoff optimization. In the filter architecture shown in FIG. 22, a chroma branch can employ smaller number of the BB, e.g. N_{c}<N_{y} or reduced number of channels, e.g. Cᵤᵥ<Cy or Cᵤᵥ₂₁<C_{y21}. In addition, a skip connection is depicted in the backbone block in FIG. 22, and this forms the residue block of the ResNet. In this disclosure, all the backbone blocks may be with or without the skip connection.

Certain method of separable convolution described above with respect to multi-mode CNN ILF with two-component decomposition for multiscale feature extraction and utilized in ResNet Filter Architecture described in FIGS. 17 and 18 can employ reduced decomposition ranking, thus reducing number of channels in the intermediate stage of separable decomposition.

In such filter configurations, the first stage of the decomposition, e.g. applied in a horizontal direction 3×1×C1×R, reduces the number of output features, if R<C1. In the second stage, with application of convolution in vertical directions, 1×3×R×C2, the number of features is increased, if R<C2. This may lead to certain prioritization of the features in vertical direction. This might lead to a non-optimal filtering/feature extraction due to the bottleneck introduced by using the fixed directional kernels.

In order to address the aforementioned problem, certain architecture may flip (switch the order of) the directions of the decomposed kernels in the sequence of the applied blocks. The examples described below are proposed based on the UF (unified filter) architecture and address decompositions in the residue blocks. Switching order decomposition can be utilized in other blocks of the CNN filters, e.g., in the headblock or tail block, if the CNN filters employ decomposition of the multi-dimensional convolutions.

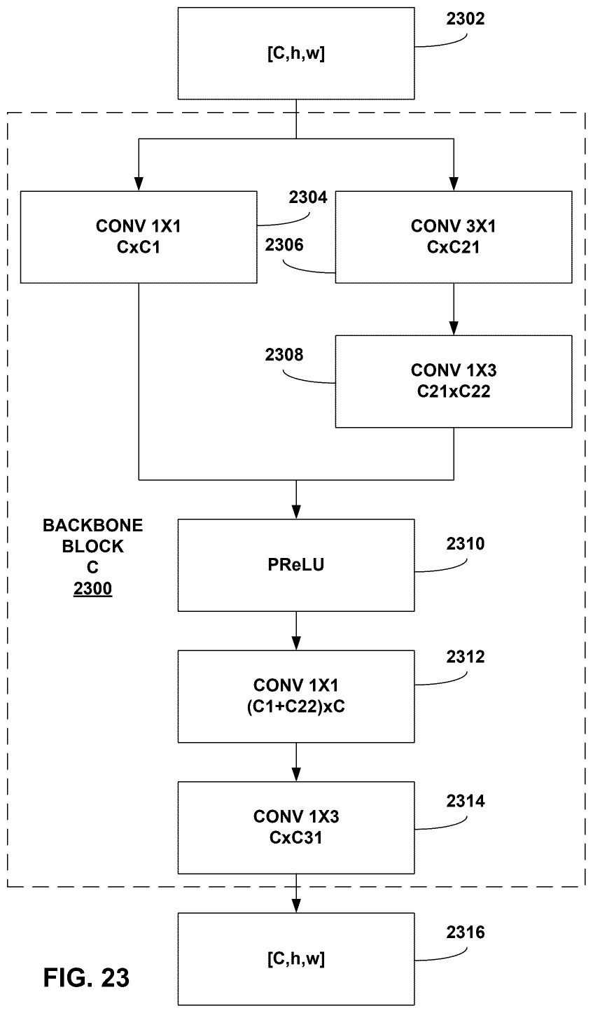

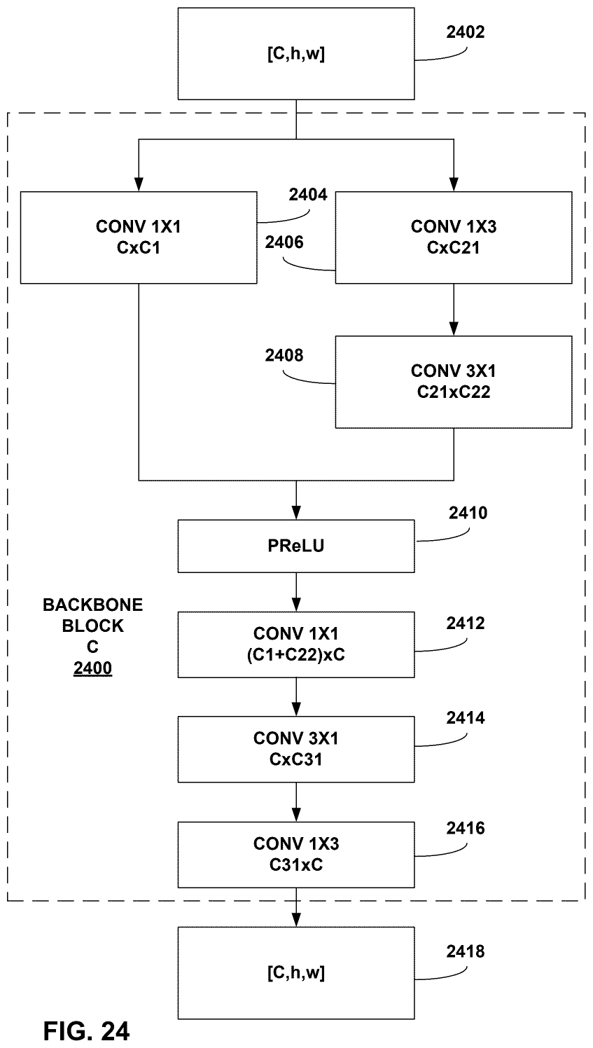

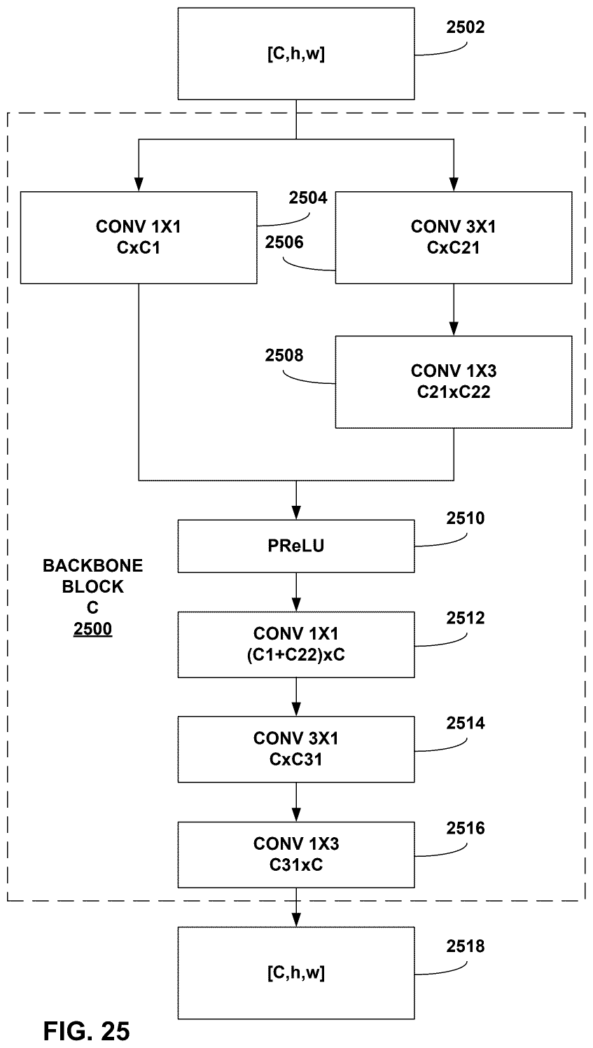

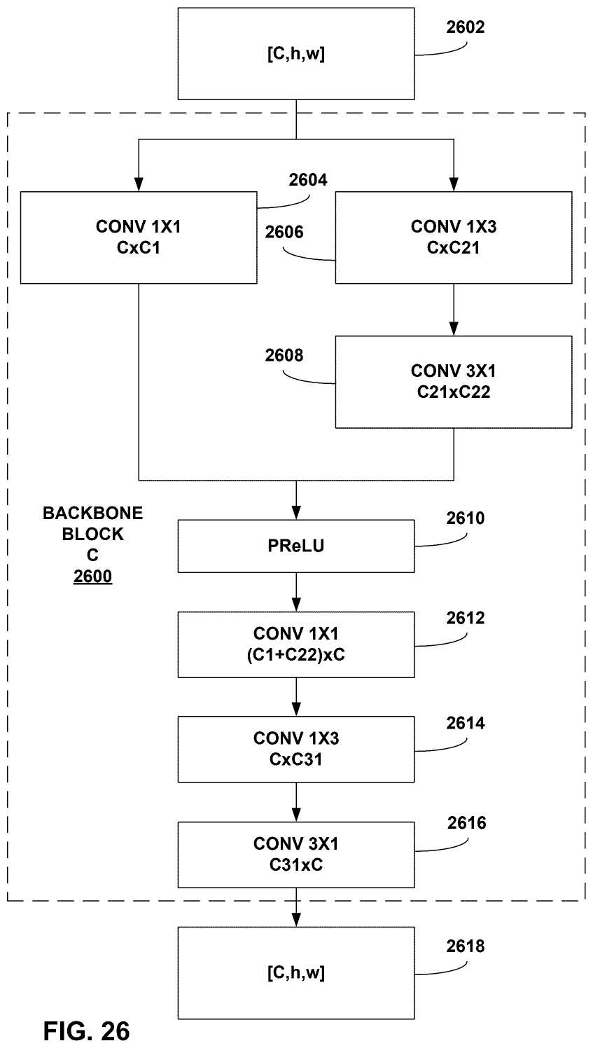

An example of backbone residue blocks with different kernel directions are shown in FIG. 23, FIG. 24, FIG. 25, and FIG. 26, respectively. In FIG. 23, the input to backbone block C 2300 (also called backbone block 2300) is input 2302, which includes a channel (c), height (h), and width (w) of a block. Convolution unit 2304 performs convolution on input 2302 by applying a 1×1 convolution with parameters C and C1. Convolution unit 2306 performs convolution on input 2302 by applying a 3×1 convolution with parameters C and C21. Convolution unit 2308 performs convolution on the output of convolution unit 2306 by applying a 1×3 convolution with parameters C21 and C22.

Parametric Rectified Linear Unit (PReLU) unit 2310 performs an activation function on the outputs of convolution unit 2304 and convolution unit 2308. Convolution unit 2312 performs convolution on the output of PRELU unit 2310 by applying a 1×1 convolution with parameters C1, C22, and C. Convolution unit 2314 performs convolution on the output of convolution unit 2312 by applying a 1×3 convolution with parameters C and C31, and outputs output 2316 as an output for another layer.

FIG. 24 illustrates backbone residue block, type 2. In FIG. 24, the input to backbone block C 2400 (also called backbone block 2400) is input 2402, which includes a channel (c), height (h), and width (w) of a block. Convolution unit 2404 performs convolution on input 2402 by applying a 1×1 convolution with parameters C and C1. Convolution unit 2406 performs convolution on input 2402 by applying a 1×3 convolution with parameters C and C21. Convolution unit 2408 performs convolution on the output of convolution unit 2406 by applying a 3×1 convolution with parameters C21 and C22.

PRELU unit 2410 performs an activation function on the outputs of convolution unit 2404 and convolution unit 2408. Convolution unit 2412 performs convolution on the output of PRELU unit 2410 by applying a 1×1 convolution with parameters C1, C22, and C. Convolution unit 2414 performs convolution on the output of convolution unit 2412 by applying a 3×1 convolution with parameters C and C31. Convolution unit 2416 performs convolution on the output of convolution unit 2414, by applying a 1×3 convolution with parameters C31 and C and outputs output 2418 as an output for another layer.

FIG. 25 illustrates backbone residue block, type 3. In FIG. 25, the input to backbone block C 2500 (also called backbone block 2500) is input 2502, which includes a channel (c), height (h), and width (w) of a block. Convolution unit 2504 performs convolution on input 2502 by applying a 1×1 convolution with parameters C and C1. Convolution unit 2506 performs convolution on input 2502 by applying a 3×1 convolution with parameters C and C21. Convolution unit 2508 performs convolution on the output of convolution unit 2506 by applying a 1×3 convolution with parameters C21 and C22.

PRELU unit 2510 performs an activation function on the outputs of convolution unit 2504 and convolution unit 2508. Convolution unit 2512 performs convolution on the output of PRELU unit 2510 by applying a 1×1 convolution with parameters C1, C22, and C. Convolution unit 2514 performs convolution on the output of convolution unit 2512 by applying a 3×1 convolution with parameters C and C31. Convolution unit 2516 performs convolution on the output of convolution unit 2514 by applying a 1×3 convolution with parameters C31 and C, and outputs output 2518 as an output for another layer.

FIG. 26 illustrates backbone residue block type 4. In FIG. 26, the input to backbone block C 2600 (also called backbone block 2600) is input 2602, which includes a channel (c), height (h), and width (w) of a block. Convolution unit 2604 performs convolution on input 2602 by applying a 1×1 convolution with parameters C and C1. Convolution unit 2606 performs convolution on input 2602 by applying a 1×3 convolution with parameters C and C21. Convolution unit 2608 performs convolution on the output of convolution unit 2606 by applying a 3×1 convolution with parameters C21 and C22.

PRELU unit 2610 performs an activation function on the outputs of convolution unit 2604 and convolution unit 2608. Convolution unit 2612 performs convolution on the output of PRELU unit 2610 by applying a 1×1 convolution with parameters C1, C22, and C. Convolution unit 2614 performs convolution on the output of convolution unit 2612 by applying a 1×3 convolution with parameters C and C31. Convolution unit 2616 performs convolution on the output of convolution unit 2614 by applying a 3×1 convolution with parameters C31 and C, and outputs output 2618 as an output for another layer.

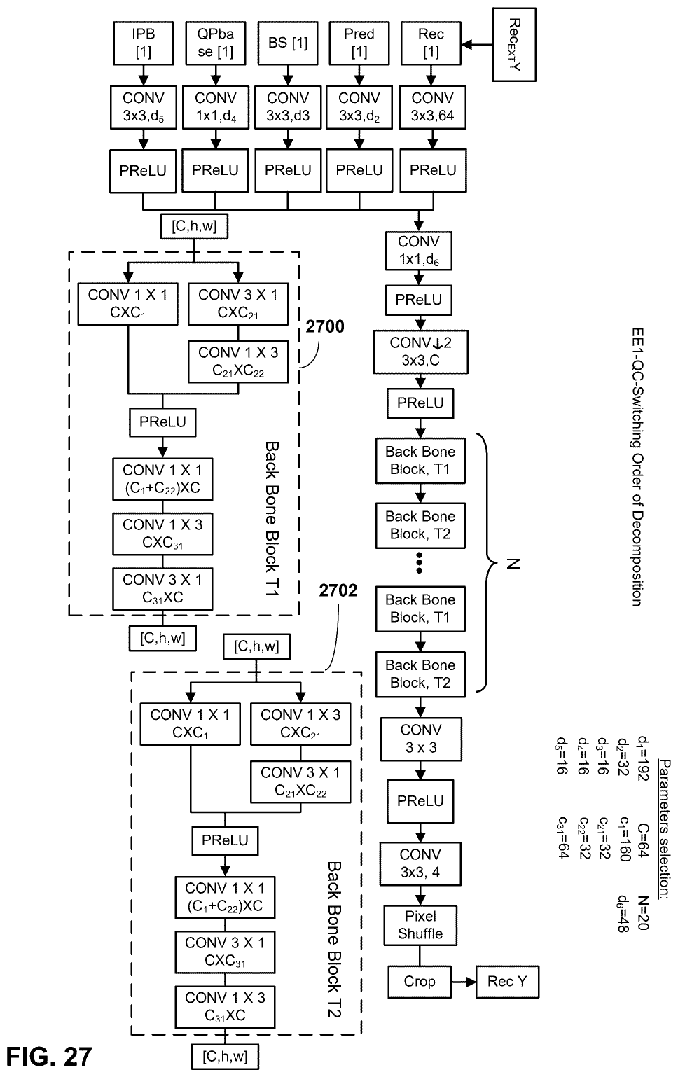

In some examples, it may be possible to alternate or mix backbone network 1 and 2 (e.g., type 1 of FIG. 23 and type 2 of FIG. 24) in a sequence for feature extraction. In another example, network 3 and 4 (e.g., type 3 of FIG. 25 and type 4 of FIG. 26) can be alternated and mixed in a sequence. In another example, network 1, 2, 3, and 4 can be mixed alternatively. For example, FIG. 27 illustrates an example of a proposed switched order decompositions (Type 1 and Type 2) integrated into a unified filter architecture (luma filtering). For example, FIG. 27 illustrates backbone block T1 2700 and backbone block T2 2702 in which the order decompositions are switched.

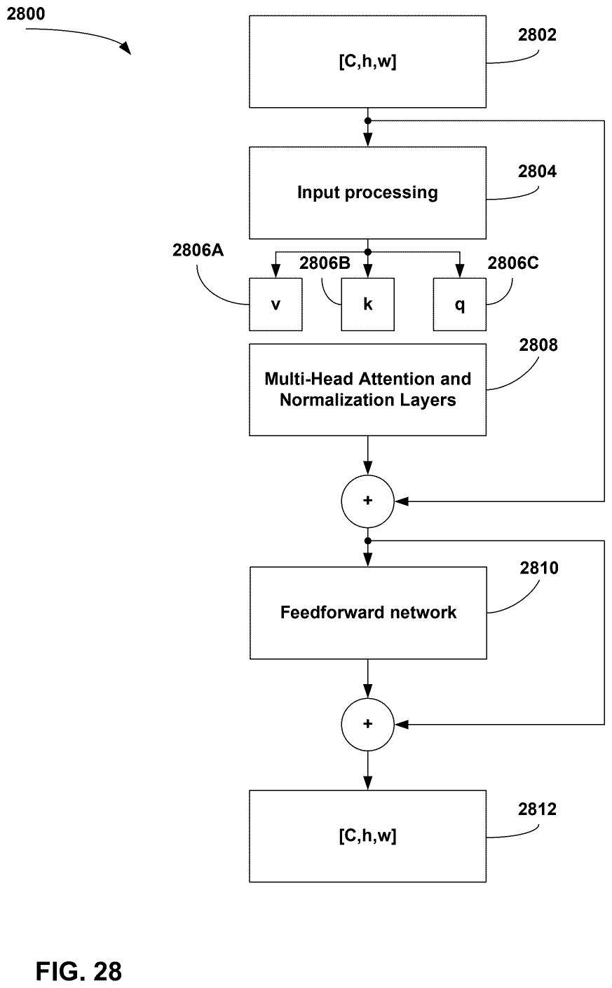

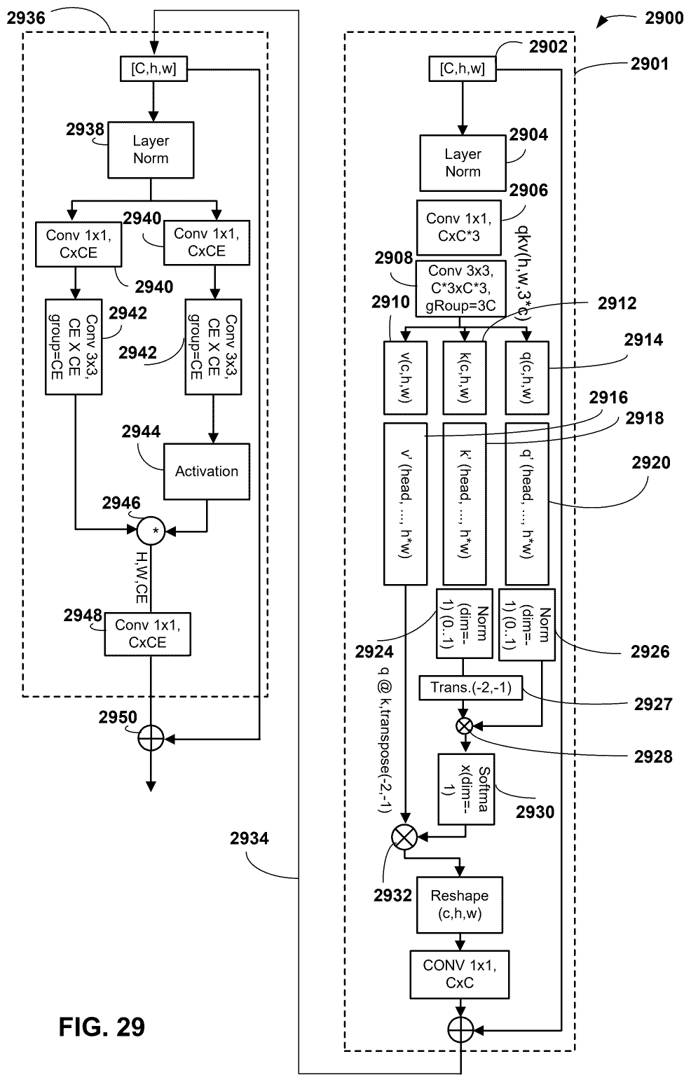

FIG. 28 illustrates a high-level overview of the Transformer block. FIG. 28 illustrates transformer block 2800 that receives as input 2802, which includes a channel (c), height (h), and width (w) of a block. Transformer block 2800 performs input processing 2804, described in more detail with respect to FIG. 29 to generate value component 2806A, key component 2806B, and query component 2806C. Value component 2806A, key component 2806B, and query component 2806C may be fed to multi-head attention and normalization layers 2808, also described in FIG. 29.

The output from the multi-head attention and normalization layers 2808 is summed with the input 2802, and the result is output to feedforward network 2810, also described in FIG. 29. The output of feedforward network 2810 is summed with the input of feedforward network 2810, and the result is output 2812 that is used for further processing.

One example of the detailed implementation can be seen in FIG. 29. FIG. 29 shows example of transformer block architecture for transformer block 2900, in which the query (q), key (k), and value (v) component are created from the input. Transformer block 2900 is an example of transformer block 2800 of FIG. 28. Transformer block 2900 includes attention block 2901 and feed forward network (FFN) 2936.

Attention block 2901 may include input processing 2804 and multi-head attention normalization layers 2808 of FIG. 28 as examples. Attention block 2901 is an example of attention block architecture, in which, the query, key, and value components (e.g., query component 2806C, key component 2806B, and value component 2806A) are created from the input (e.g., input 2802).

As described in more detail, in FIG. 29, after the channel arrangement, which prepares for performing the attention mechanism, the matrix multiplication between the query and key matrices generates the correlation between channels (e.g., attention map). This correlation (e.g., attention map) is translated into a weight matrix of probability after the Softmax layers. Applying the weight matrix with the value matrix (e.g., with an element-wise multiplication), information from other channels is aggregated to each channel. In addition, when multiple heads are used in the transformer, the attention from each head is computed separately, and the results are aggregated. For instance, an attention map may be indicative of correlation (e.g., cross-correlation) between elements of the feature in a block. As an example, the attention map in the context of self-attention/transformer is produced by a transposed matrix multiplication of query (e.g., query component 2806C) and key (e.g., key component 2806B).

For example, the input to attention block 2901 is input 2902, which may be intermediate output of an internal component of a backbone block or an output from a backbone block, like backbone blocks 2300 to 2600. For instance, input 2902 may be the output of convolution unit 2616 (FIG. 26). However, the input 2902 may be values such as the output of convolution unit 2608 (FIG. 26) (e.g., which is an internal component of backbone block 2600).

Layer norm unit 2904 (e.g., term Layer Norm) may define the process of Layer Normalization, that uses the distribution of all inputs to a layer to compute a mean and variance which are then used to normalize the input to that layer. Convolution unit 2906 may apply a 1×1 convolution to the output of layer norm unit 2904. Convolution unit 2908 may apply a 3×3 depth-wise convolution to the output of convolution unit 2906, and generate value matrix 2910, key matrix 2912, and query matrix 2914. For instance, convolution unit 2906 and 2908 may determine query matrix 2914 as Q=XWq, key matrix 2912 as K=XWk, and value matrix 2910 as V=XWv. X may be the input sequence (e.g., input values), and Wq, Wk, and Wv may be learned weighted matrices for the query matrix 2914, key matrix 2912, and value matrix 2910.

In one or more examples, video encoder 200 and video decoder 300 may generate q(head, c/head, h*w) matrix, k′(head, c/head, h*w) matrix, and v(head, c/head, h*w) matrix, where “head” is a parameter used for dividing the processing across different processing circuitry. The use of q(head, c/head, h*w) matrix, k′(head, c/head, h*w) matrix, and v(head, c/head, h*w) matrix is not needed in all examples. The k′(head, c/head, h*w) matrix is used to indicate the rearrangement of the k(c, h, w) matrix.

Norm unit 2926 may normalize the values from the query matrix or after rearrangement/reshaping using “head” to values between 0 and 1. Norm unit 2924 may normalize the values from the key matrix or after arrangement using “head,” to values between 0 and 1. That is, term Norm defines the process of input normalization, rescaling magnitude of the input samples to the range 0 . . . 1. Transpose unit 2927 may be configured to perform a transpose of the result of apply the key matrix 2912.

Matrix multiplier 2928 may multiply the output of norm unit 2926 and the transpose of output of norm unit 2924 (e.g., output of transpose unit 2927) to generate an attention map. That is, operation matrix multiplication is defined by term [symbol] in FIG. 29. In this manner, transformer block 2900 may perform a matrix multiplication between a query matrix (e.g., output of norm unit 2926) and a transposed key matrix (e.g., output of norm unit 2924 after transposing with transpose unit 2927) to generate an attention map. The query matrix 2914 and the key matrix 2912 may be generated based on an input that includes a luma component and one or more chroma components of the picture. That is, the input may include a luma component and one or more chroma components of the picture or features extracted from the luma component and the one or more chroma components.

Transformer block 2900 may translate the attention map into a weight matrix of probability. For example, the matrix multiplication between the query and key matrices transposed (e.g., outputs of norm unit 2926 and norm unit 2924 after transposing with transpose unit 2927) generates the attention map in a channel-wise manner. This attention map is translated into a weight matrix of probability after the Softmax unit 2930. For example, Operation SoftMax of Softmax unit 2930 may be a normalized exponential function that is used as an activation function of a neural network to normalize the output of a network to a probability distribution over predicted output classes. For each input element zi, Softmax unit 2930 applies exponential function and normalizes these values by dividing them by the sum of these exponential functions:

$${σ ( \vec{z} )}_{i} = \frac{{e}^{\text{?}}}{{\sum }_{j = 1}^{K} {e}^{\text{?}}}$$

$$\text{?} \text{indicates text missing or illegible when filed}$$

Matrix multiplier 2932 may multiply the output of Softmax unit 2930 with the value matrix 2910 or possibly after the “head” reshaping operation. After the multiplication, attention block 2901 may perform additional processing to generate features 2934 that capture the distant, non-local correlations, relative to the current block of video data and the non-proximate samples, in the picture for processing. In this manner, attention block 2901 of transformer block 2900 may generate features, based on applying an attention mechanism, that capture the distant, non-local correlations, relative to the current block of video data and the non-proximate samples, in the picture for processing. Applying the weight matrix with the value matrix, information from other channels is aggregated to each channel. Stated another way, transformer block 2900 may apply the weight matrix (e.g., output from Softmax unit 2930) to a value matrix 2910 or 2916 to apply the attention mechanism. The value matrix 2910 or 2916 may be generated from the input 2902.

The transformer block 2900 may also include a Feed Forward Network (FFN) 2936. The FFN 2936 further processes the information (e.g., features 2934 generating by applying the attention mechanism) to provide a more flexible representation of the output for the training or inference. In FFN 2936, layer norm unit 2938 may perform similar operations as layer norm unit 2904. Convolution unit 2940 may perform 1×1 convolution, and convolution unit 2942 may perform 3×3 depth-wise convolution. There may be two branches out of convolution unit 2942. A first branch includes activation unit 2944, which may be implemented as point-wise non-linearity, examples of which may include Gaussian Error Linear Unit (GELU), Rectified Linear Unit (ReLU) or other implementations. The output from the activation unit 2944 may be one input to point-wise multiplier 2946. The other input to matrix multiplier 2946 may be the output from convolution unit 2942. Point-wise multiplication is defined by term ⊙ in FIG. 29. The output of matrix multiplier 2946 may be further processed by convolution unit 2948 and added by adder 2950 to the extracted features by using the features 2934 to generate an output that is further processed as an input to the next backbone block or to the next component inside a backbone block.

In some examples, different configuration of Transform and ResNet architectures may be used to achieve a target complexity-performance tradeoff. Non-limiting examples are described below, such as number of backbone blocks, rank of decomposition, and transformer architecture.

For the number of backbone blocks, introduction of transformer blocks (e.g., like transformer block 2900) may increase computation complexity. To keep the complexity within the capability of video encoder 200 and video decoder 300 to timely process, a number of residual transformer-enabled blocks may be lower than a number of residual block without transformers. That is, there may be some backbone blocks without an associated transformer block, but there may be other backbone blocks that are each associated with a transformer block. In some examples, an ILF architecture with a transformer block in a backbone may be in range of 3 to 14 backbone blocks for Luma or for joint luma/chroma processing.

For rank of decomposition, in some examples, rank of the separable convolutions may be reduced (similarly to examples described above) for filter architecture with transformers. Examples of such architecture may be in-loop filters (ILF) with C31=48 or smaller than number of input channels C.

For transformer architectures, to control complexity of the transformer block (e.g., like transformer block 2900), several configuration parameters can be used. Examples of those configuration parameters include: factor intermediate channel expansion within an FFN part of a transformer can be within range of C*1*3 . . . . C*4*3 or higher, with C being an number of input channels. In some examples, a number of transformer heads can be set equal to 1, 2, 4, 8 or higher. In some examples, a number of the intermediate channels resulting from transformer heads can be altered to be divisible by 16 or 8, or 4 or 2.

In some examples, spatial attention between non-overlapping block of size N×N within each channel can be applied, where the parameter N can be set as 2, or 3, etc. In some examples, a simplified feed forward network (FFN) can be utilized, where the FFN only consists of convolution and activation layers (e.g. omitting Layer Normalization). In some examples, the transformer block may be placed outside of the ResBlock of the backbone or in a one of the multi-scalar branches of the residual block (e.g., backbone block).

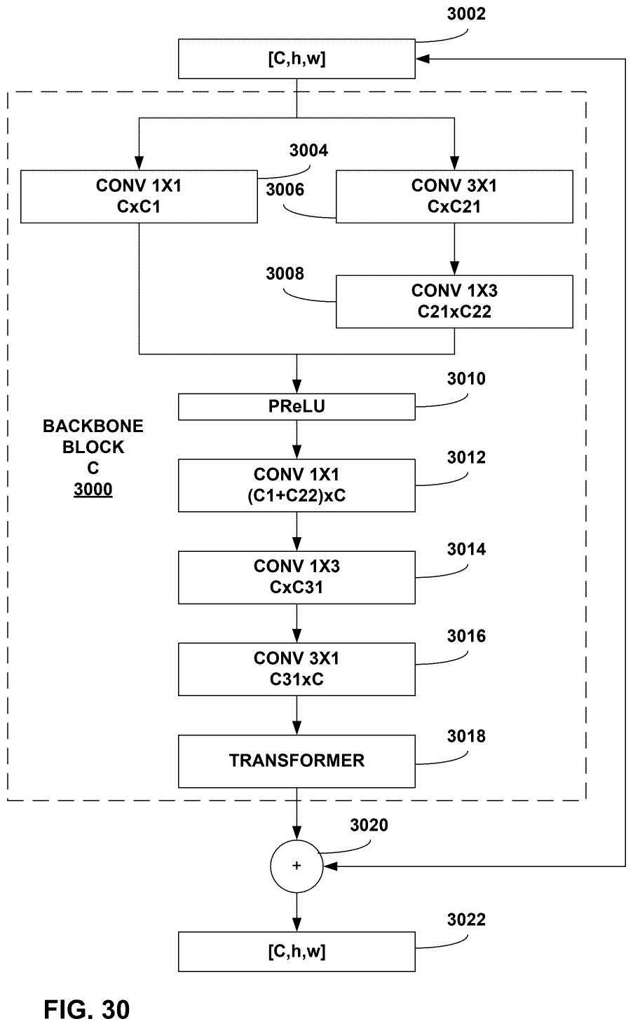

FIG. 30 illustrates inserting the Transformer block into the residue backbone block of the filtering architecture. To improve performance of ResNet based filters (e.g., by employing non-local information in the training process), the example techniques may include a transformer block associated with each backbone block (e.g., in each Backbone block or coupled to a backbone block). Example of such architecture is shown in FIG. 30, where residue block of the backbone architecture are being improved by cascading with Transformer block 3018, as illustrated.

In FIG. 30, the input to backbone block 3000 is input 3002, which includes a channel (c), height (h), and width (w) of a block. Convolution unit 3004 performs convolution on input 3002 by applying a 1×1 convolution with parameters C and C1. Convolution unit 3006 performs convolution on input 3002 by applying a 3×1 convolution with parameters C and C21. Convolution unit 3008 performs convolution on the output of convolution unit 3006 by applying a 1×3 convolution with parameters C21 and C22.

PRELU unit 3010 performs an activation function on the outputs of convolution unit 3004 and convolution unit 3008. Convolution unit 3012 performs convolution on the output of PRELU unit 3010 by applying a 1×1 convolution with parameters C1, C22, and C. Convolution unit 3014 performs convolution on the output of convolution unit 3012 by applying a 1×3 convolution with parameters C and C31. Convolution unit 3016 performs convolution on the output of convolution unit 3014 by applying a 3×1 convolution with parameters C31 and C.

Transformer block 3018 receives the output of convolution unit 3016 and applies an attentional mechanism (also called a non-local attention) that captures distant, non-local correlations, relative to a current block of video data and non-proximate samples to the current block of video data. That is, the various units or blocks of backbone block 3000 that are similar to units and blocks of backbones 2300-2600 may be configured to capture local correlations, relative to the current block of video data and samples proximate the current block of video data. Transformer block 3018 may be configured to capture distant, non-local correlations. In this manner, the example techniques may be able to account for long-range dependencies (e.g., correlations with non-proximate samples in a current block of video data).

For instance, as described above with respect to FIG. 29, transformer block 3018 may include an attention block and a feed forward network (FFN). The attention block may be configured to generate features, based on applying an attention mechanism, that capture the distant, non-local correlations, relative to the current block of video data and the non-proximate samples, in the picture for processing. That is, the output of the attention block may be features, and these features may capture the distant, non-local correlations, relative to the current block of video data and the non-proximate samples, in the picture for processing, such as by the FFN. The attention mechanism may be based on a query matrix, a key matrix, and a value matrix, as described in more detail.

For example, video encoder 200 or video decoder 300 (e.g., part of in-loop filtering) may be configured to filter a current block of video data of a picture of the video data, through a neural network and based on local correlations of proximate samples and distant, non-local correlations of non-proximate samples relative to the current block of video data, to generate a filtered current block of video data. In the example illustrated in FIG. 30, transformer block 3018 may be configured to generate an attention map, using the query and key matrix, based on global information and perform the attention mechanism that captures distant, non-local correlations.

For instance, the neural network includes one or more backbone blocks (e.g., like backbone block 3000) and one or more transformer blocks (e.g., like transformer block 3018). Each of the one or more transformer blocks (e.g., transformer block 3018) is associated with a backbone block 3000 of the one or more backbone blocks. For example, transformer block 3018 is part of the backbone block 3000 and receives an intermediate output of an internal component of the backbone block 3000. For example, transformer block 3018 receives output from convolution unit 3016, which is an intermediate output of an internal component of residual backbone block 3000 (e.g., convolution unit 3016 is an internal component of backbone block 3000).

At least one of the backbone blocks (e.g., backbone block 3000) may be configured to capture the local correlations, relative to a current block of video data and proximate samples of the current block of video data. For example, convolution units 3004, 3006, and 3008 may be configured to capture the local correlations, relative to a current block of video data and the samples proximate the current block of video data.

At least one of the transformer blocks (e.g., transformer block 3018) may be configured to generate features, based on applying an attention mechanism, that capture the distant, non-local correlations, relative to the current block of video data and the non-proximate samples, in the picture for processing. That is, transformer block 3018 may be configured to perform an attention mechanism that captures distant, non-local correlations, relative to the current block of video data and the non-proximate samples, in the picture for processing. For example, as described above with respect to FIG. 29, transformer block 3018 may generate query, key, and value components that used to apply (e.g., perform) an attention mechanism.

In general, one or more example transformer blocks described in this disclosure may be based on a self-attention mechanism, as a non-limiting example. Transformer block 3018 may be perform a self-attention, or scaled dot-product attention, by computing a weighted representation of the input sequence by allowing the neural network of which transformer block 3018 is part to weigh the importance of different values in relation to each other. For example, in transformer block 3018, the attention map may be computed by using the query and key component based on the global information related to a block, and the attention mechanism is further performed by using a transposed matrix multiplication to the value component, where the query, key and value components are features computed from the same input with linear/nonlinear functions. The input may be based on a luma component and one or more chroma components of the picture or features extracted from the luma component and one or more chroma components.

Transformer block 3018 may use three matrices or vectors, query (q) matrix or vector, key (k) matrix or vector, and value (v) matrix or vector, which may also be referred to as q component, k component, and v component, respectively. The use of the query matrix, key matrix, and/or value matrix may be referred to as applying attention mechanism that captures the distant, non-local correlations, relative to the current block of video data and the non-proximate samples, in the picture for processing. For instance, for filtering a current block of video data, transformer block 3018 may utilize the q component, k component, and v component to generate features for processing, where the features capture the distant, non-local correlations, relative to the current block of video data and the non-proximate samples, in the picture for processing. In this manner, filtering the current block of video data may not be limited to proximate samples and local correlations, but incorporates an attention mechanism to capture distant, non-local correlations of non-proximate samples.

The query vector represents the current input values for which the neural network for filtering is trying to find relevant context or information from other samples in the sequence. The key vector is associated with each input in the input sequence and can be thought of as a tag or identifier that represents what specific inputs values are about. The value vector holds the actual information that will be combined to create the output representation.

Transformer block 3018 may determine query matrix as Q=XWq, key matrix as K=XWk, and value matrix as V=XWv. X may be the input sequence (e.g., input values), and Wq, Wk, and Wv may be learned weighted matrices for the query matrix, key matrix, and value matrix. In one or more examples, the Wq, Wk, and Wv matrices may be learned, during a learning phase, based on training data where samples in addition to the proximate samples of a current block of video data are used to train the neural network used for filtering. In this manner, the attention mechanism that transformer block 3018 applies (e.g., performs) captures distant, non-local correlations, relative to the current block of video data and the non-proximate samples. That is, Wq, Wk, and Wv may be learned matrices. Then during inference, where transformer block 3018 is operating on current video data, including a current block of video data, video encoder 200 and video decoder 300 may be able to perform filtering on the current block of video data using distant, non-local correlations that are captured through the use of the Wq, Wk, and Wv matrices (e.g., with matrix multiplication, including transposed matrix multiplication).

In one or more examples, transformer block 3018 may also include a feed forward network that receives the features after applying the attention mechanism, and performs additional operations so that the information (e.g., features) are in condition for further processing and to refine the features so that the features are more informative. For example, backbone block 3000 may be in a cascade chain of backbone blocks that together form a portion of the neural network based filter. The feed forward network of transformer block 3018 may generate information that can be fed to the next backbone block in the cascade chain.

Adder unit 3020 may add the output from transformer block 3018 and input 3002. The output of adder unit 3020 may be the output values 3022 that is further processed by the next backbone block in the cascade. Adder unit 3020 may not be needed in all examples, and the output of transformer block 3018 may be output values 3022.

Layer norm unit 2904, norm unit 2924, norm unit 2926, and softmax unit 2930 may be considered as having non-linear layers because performing the operations of layer norm unit 2904, norm unit 2924, and norm unit 2926 involves non-linear operations such as exponential and square root operations. Such operations may not be hardware friendly (e.g., utilize excessive processing power or time). Accordingly, it may be possible to remove the normalization and softmax layers to improve hardware friendliness.

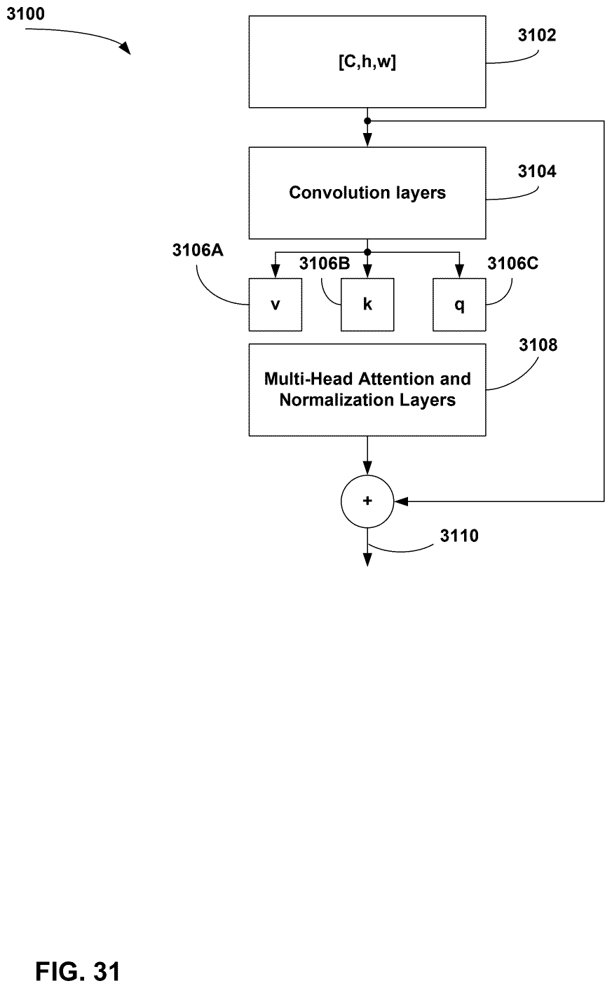

After removing the nonlinear layers, an example of the attention module/block is derived, which is shown in FIG. 31. For example, attention block 3100 may be similar to the attention block 2910 (FIG. 29) or portions other than the feedforward network 2810 of transformer block 2800 (FIG. 28). However, attention block 3100 includes convolution layers 3104. For example, input 3102 is output to convolution layers 3104 that generates value component 3106A, key component 3106B, and query component 3106C that are fed to multi-head attention and normalization layers 3108. The output of multi-head attention and normalization layers 3108 is summed with input 3102 to generate output 3110. In some examples, a feedforward network may not be needed, and output 3110 may be fed to the next backbone block in the sequency of backbone blocks (e.g., as illustrated in FIG. 27 and elsewhere). In some examples, use of a feedforward network may be possible, and output 3110 may be fed to a feedforward network.

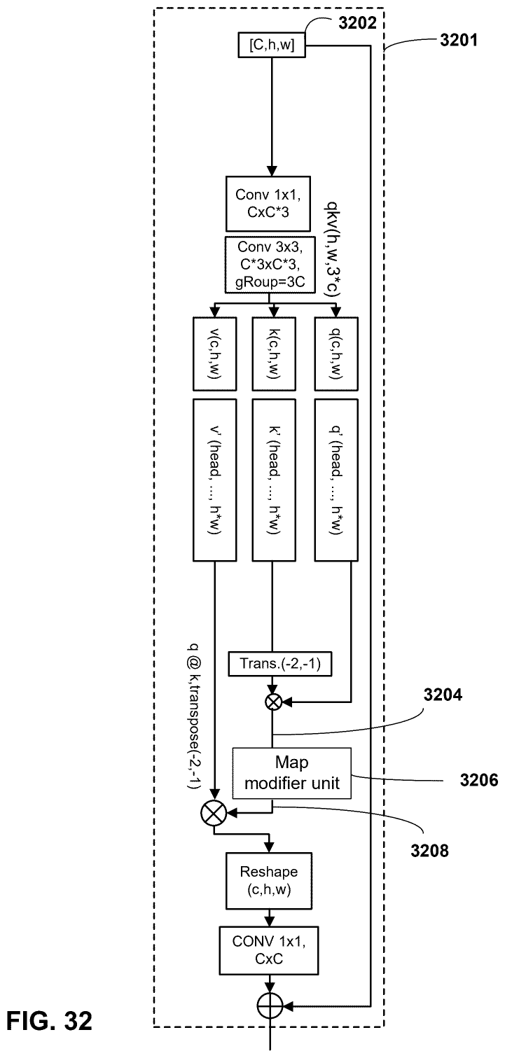

FIG. 32 shows an example of attention block architecture, in which, the normalization and softmax layers are removed, and all the operators inside the module can be quantized in a straight-forward manner. For instance, in FIG. 32, attention block 3201 receives inputs 3202. Attention block 3201 of FIG. 32 and attention block 2901 of FIG. 29 may be similar. However, attention block 3201 may not include normalization (e.g., layer norm 2904, norm unit 2926, norm unit 2924) and softmax layers (e.g., softmax unit 2930) of attention block 2901. The other components of attention block 3201 may be similar to attention block 2901.

In accordance with one or more examples, and as described in more detail, attention block 3201 may include a map modifier unit 3206 that modifies the attention map 3204 based on a size of blocks used for training and the current block size the NN-ILF to generate a modified attention map 3208. For instance, attention map 3204 may be based on a size of a current block of video data being filtered, and the larger the attention map 3204 may lead to a larger activation value in the output feature data than what the NN-ILF was trained for. For example, the end-to-end training of the NN-ILF, such as in FIGS. 8-22, 27, or other NN-ILFs may include feeding training blocks for filtering with ground truths to adjust the weights and offsets of the neural network. If the activation value in the output feature data is different (e.g., larger) than what the NN-ILF was trained for, which may be the case based on block size, the filtering effectiveness may be reduced.

To improve the filtering effectiveness, map modifier unit 3206 may modify the attention map 3204 based on a size of blocks used for training the NN-ILF to generate a modified attention map 3208. As one example, map modifier unit 3206 may determine a scale factor based on a ratio of a number of samples in the current block of video data and a number of samples in a block used for training. Map modifier unit 3206 may scale the attention map based on the scale factor to generate the modified attention map. In some examples, the scale factor may be a ratio value of the ratio of the number of samples in the current block of video data and the number of samples in a block used for training (e.g., in each of the blocks used for training). In some examples, the scale factor may be the ratio value multiplied with a number greater than one.

As another example, map modifier unit 3206 may down-sample the attention map 3204 to match a resolution of the blocks used for training to generate modified attention map 3208. Map modifier unit 3206 may perform average pooling may be one example way to down-sample the attention map 3204 to generate modified attention map 3208. Other techniques such as interpolation, extrapolation, etc. may be possible techniques that map modifier unit 3206 performs to modify attention map 3208 and generate modified attention map 3208.

In some examples, attention block 3201 may not output to a feedforward network, such feedforward network 2936 (FIG. 29). Rather, the operations of feedforward network 2936 may be performed by attention block 3201, and attention block 3201 may be trained to perform the operations of feedforward network 2936 during training. This, rather than needing an entire transformer block, it may be possible to utilize attention block 3201. However, it may be possible for attention block 3201 to output to feedforward network 2936 or another feedforward network.

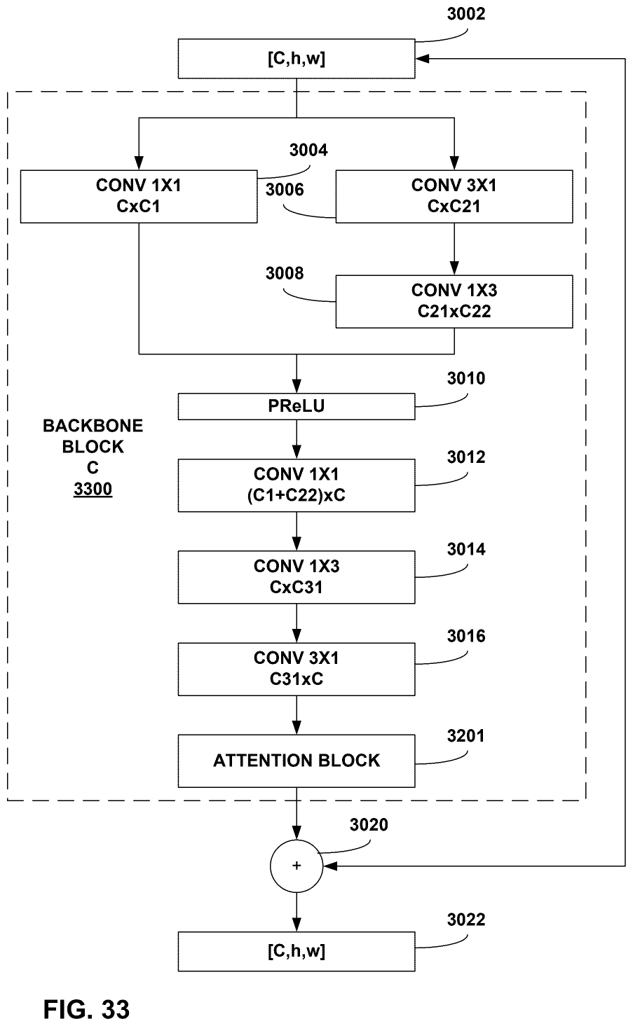

An example of placing the attention block is shown in FIG. 33, where the placement is at the end of the backbone block. For example, backbone block C 3300 (also called backbone block 3300) may be similar to backbone block 3000 (FIG. 30), and similar reference numerals are used to identify similar components. However, in the example of FIG. 33, attention block 3201 (e.g., of FIG. 32) may be used instead of transformer block 3018 of FIG. 30.

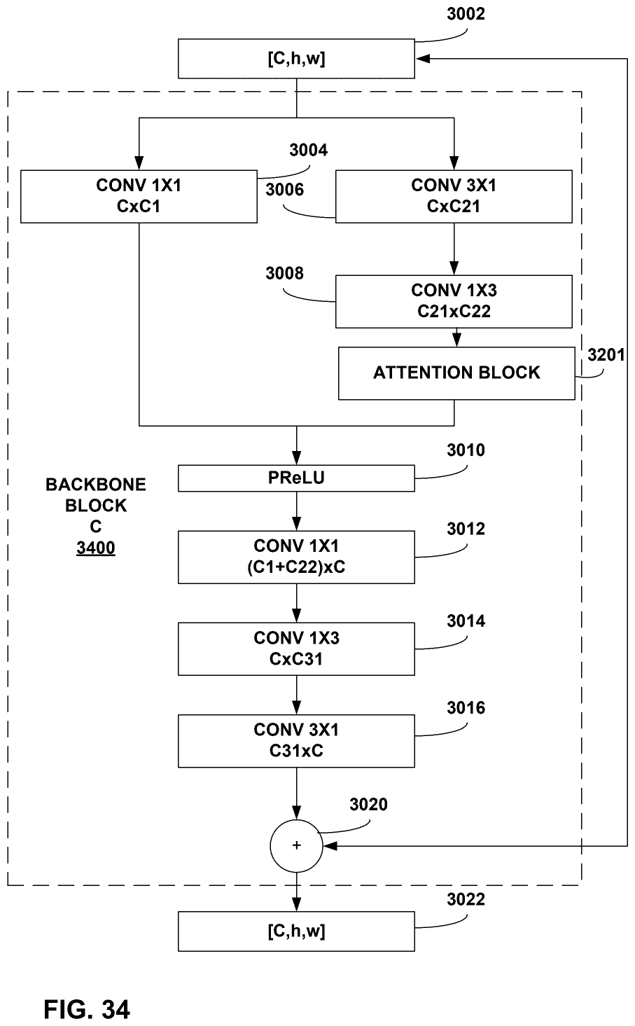

Other examples of placing the blocks is shown in FIGS. 34, FIG. 35, and FIG. 36. For example, in FIG. 34, backbone block C 3400 (also referred to as backbone block 3400) is similar to backbone block 3300 or 3000. However, attention block 3201 (e.g., of FIG. 32) receives the output of convolution unit 3008, and outputs to PRELU unit 3010.

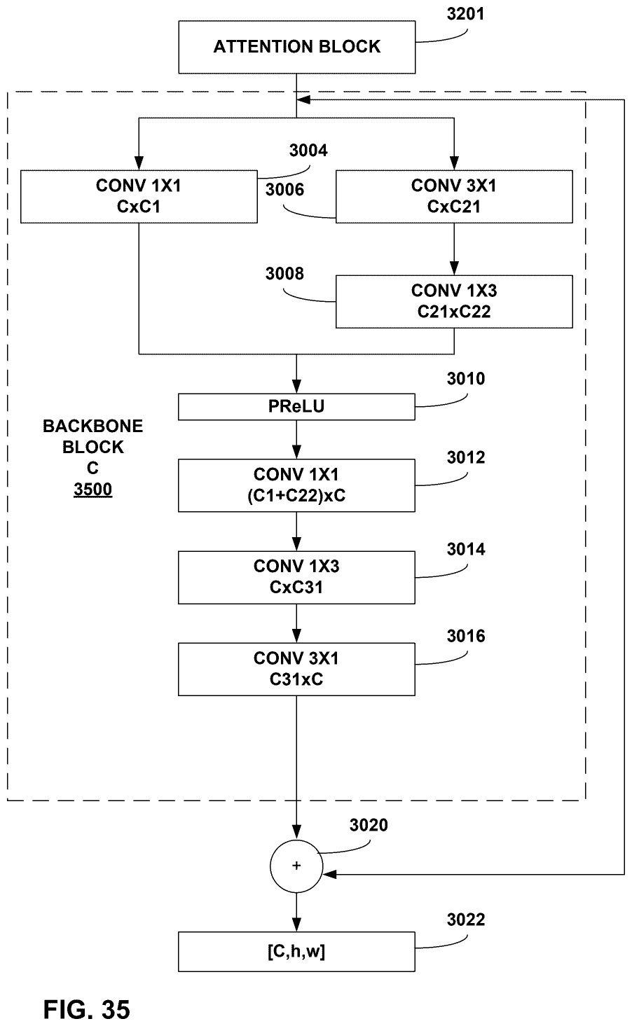

In FIG. 35, backbone block C 3500 (also called backbone 3500) is similar to backbone block 3400, 3300, or 3000. However, attention block 3201 (e.g., of FIG. 32) receives the output of a previous backbone block in the cascade of backbone blocks.

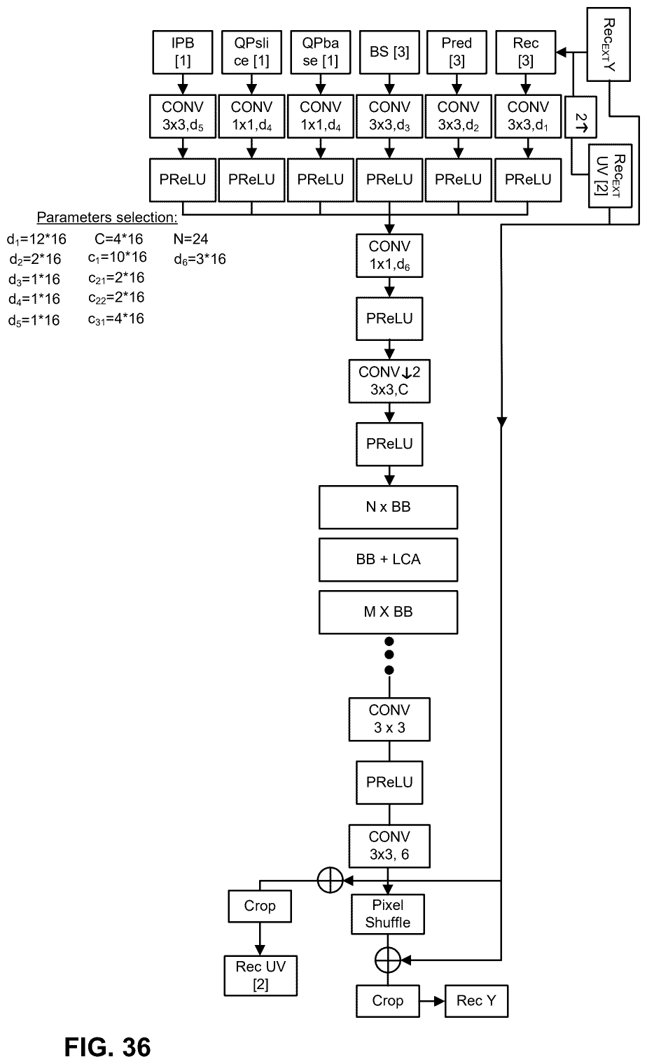

FIG. 36 illustrates the unified filter of FIG. 19. However, backbone blocks of FIG. 19 are replaced by backbone blocks that include attention blocks, such as attention block 3201 (e.g., of FIG. 32). For instance, in FIG. 36, N×BB and M×BB indicates there are N×M backbone blocks, and BB+LCA (low complexity attention block) indicates that each of the backbones includes an attention block, like attention block 3201.

In FIGS. 34-36, attention block 3201 is one example, and other attention blocks may be used. For instance, attention block 2901 may be used instead of attention block 3201. Also, although feedforward network, like feedforward network 2936, is not illustrated, it may be possible that there is a feedforward network along with the attention blocks is used.

ResNet with Transformer blocks described above with respect to the unified CNN ILF with transform blocks, such as in FIG. 28, utilize Transformer modules and a sequence of ResNet backbone blocks that include a cascade of convolutions with non-linear operations, e.g., PreLU. Because the transformer block involves operators, e.g., Softmax, LayerNorm, and Norm that are non-hardware friendly, therefore, an Attention block is derived from the transformer to improve and accelerate the filtering. However, the attention map (e.g., from attention block 3201) is unnormalized in this model and may not be adaptive to block-size changes. With a bigger block size during the inference, the attention mechanism with a dot product (element-wise multiplication and addition) leads to a larger activation value in the output features than what it is trained for. This leads to a performance degradation in the inference time. That is, relying on attention map 3204, without use of map modifier unit 3206, may result in worse filtering effectiveness of filtering a current block of video data.

To improve the inference performance with an efficient hardware implementation and be able to adapt to variable input block size (e.g., dynamic input block size), this disclosure describes example techniques to add an algorithm to normalize the attention map (e.g., using map modifier unit 3206), the corresponding features, or the activations produced by using the attention map.

The following is the training and inference mechanism in the current implementation of the filter in JVET in more detail, where a fixed-input block size of 128×128 plus an extension of 8 on the boundaries (i.e., 144×144) is used for the training of the neural network in-loop filter (NN-ILF), and the block size may be changed during the inference to a maximum of 256×256 plus an extension of 8 (i.e., 272×272). That is, the training of the NN-ILF included fixed-input block size, but during inference (e.g., filtering of the current block of video data), a size of the current block of video data may not be fixed, and may be different than the size of the blocks used for training.

In order to improve the adaptability of the attention mechanism, the following approaches may be applied. The following example techniques may be used together or separately. In some examples, map modifier unit 3206 may be configured to modify attention map 3204 using only linear operations (e.g., operations that exclude exponential or square root operations) to generate modified attention map 3208. In some examples, map modifier unit 3206 may use other techniques such as look-up tables or other such techniques to modify attention map 3204 may generate modified attention map 3208 that are hardware friendly (e.g., do not require excessing processing power or time, and can be performed by less complex hardware).

In one example, the ratio of the input block size between the inference time and the training time can be utilized to scale the attention map 3204. For example, if the spatial input-block size in total number of pixels is S1 (e.g., a number of samples in the current block of video data being filtered is S1) for the inference and S2 for the training (e.g., a number of samples in blocks used for training is S2), the attention-map matrix M (e.g., attention map 3204) may be scaled by a simple division of K, i.e., M/K, where K=S1/S2, and M is produced with the q and k after transposed matrix multiplication in FIG. 32. In one example, the division factor K can be slightly bigger, e.g., K=K*115%. In addition, the calculation of S1 and S2 may include or exclude block extensions.

In some examples, to modify attention map 3204, map modifier unit 3206 may determine a scale factor based on a ratio of a number of samples in the current block of video data and a number of samples in blocks used for training (e.g., determine S1/S2 as the scale factor). In some examples, map modifier unit 3206 may determine a ratio value based on the ratio of the number of samples in the current block of video data and the size of the blocks used for training (e.g., determine S1/S2), and multiply the ratio value with a number greater than one (e.g., 1.15) to determine the scale factor (e.g., K=K*115%). Map modifier unit 3206 may scale the attention map 3204 based on the scale factor to generate the modified attention map 3208.

As an example for illustration, in one example, given the training block size S2=128×128 and inference conducted with variable block size (e.g., blocks to be filtered are not required to have a fixed size), maximum of S1=256×256, the division factor K is produced as K=S1/S2=4. In one example, the extension of the block, e.g., with 8 pixels can be considered, given the training block size (with extension) S2=144×144 and inference conducted with variable block size, maximum of S1=272×272, the division factor K is produced as K=S1/S2=3.57.

In one example, during the inference stage, an n×n average pooling may be applied for both the attention map M and the corresponding features S that is produced by v in FIG. 32, and the activation is produced from the matrix multiplication of M and S. The average range n may be set to 2. This effectively down-samples the M and S matrices by half in each dimension and may result in a match of the resolution to that of the training. This pooling process can be performed before the reshaping process. In one example, the area in the feature domain corresponding to the extension of block may be excluded for the average pooling.

That is, map modifier unit 3206 may down-sample the attention map 3204 to match a resolution of the blocks used for training. As an example, map modifier unit 3206 may perform average pooling of the attention map 3204 as an example way to down-sample to generate modified attention map 3208. This pooling may be performed before the reshaping process.

In one example, the value n is defined at the training time, depending on the training constrains, e.g. patch size during training, and provided as a side information in form of LUT for the inference testing. The value is being accessible by the index corresponding to the block size being used during inference.

In one example, the inference block size (e.g., block size of the current block of video data being filtered) may be fixed to the training block size of 128×128 for video sequences of lower resolution classes, and the dynamic input block size with scaling or average pooling mentioned above may be selected for filtering of video content with certain properties, e.g. function of spatial resolution. That is, for certain spatial resolutions, there may not be a requirement that the current block of video data being filtered is set to a fixed size.

In one example, the inference block size e.g., block size of the current block of video data being filtered) may be fixed to the training block size. e.g., 128×128 for the intra prediction slices of video sequences, and the dynamic input block size with scaling or average pooling may be applied to the inter slices. For example, for inter-predicted blocks, there may not be a requirement that the current block of video data being filtered is set to a fixed size. Accordingly, the example techniques of modifying attention map 3204 to generate modified attention map 3206 may be performed only for blocks that are inter-predicted.

In one example, if the input block size is much smaller than that of the training size, a padding may be applied to the input images. In one example, interpolation or extrapolation can be employed to normalize input block size for size of the model training. In one example, data of variable block size can be utilized for the training instead of training with fixed block-size only.

The example techniques may be applicable to neural network (NN) models of different functionality and of different types of architecture and modules, which employ the integer implementation and apply quantization. Utilization of the example techniques could reduce computation complexity and memory bandwidth requirements and provide a better performance. Examples described in this document are related to NN-assisted loop filtering, however, they are applicable to NN-based video coding tools, generally, that consumes input data with certain statistical properties, such as static content or sparse representation.

FIG. 3 is a block diagram illustrating an example video encoder 200 that may perform the techniques of this disclosure. FIG. 3 is provided for purposes of explanation and should not be considered limiting of the techniques as broadly exemplified and described in this disclosure. For purposes of explanation, this disclosure describes video encoder 200 according to the techniques of VVC (ITU-T H.266, under development), and HEVC (ITU-T H.265). However, the techniques of this disclosure may be performed by video encoding devices that are configured to other video coding standards.

In the example of FIG. 3, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block of video data that is to be encoded). Memory 106 of FIG. 1 may also provide temporary storage of outputs from the various units of video encoder 200.

The various units of FIG. 3 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block of video data (e.g., a current CU, or in HEVC, the overlapping portion of a PU and a TU). For inter-prediction of a current block of video data, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block of video data, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block of video data and the reference block being considered. Motion estimation unit 222 may identify a reference block having a lowest value resulting from these calculations, indicating a reference block that most closely matches the current block of video data.

Motion estimation unit 222 may form one or more motion vectors (MVs) that defines the positions of the reference blocks in the reference pictures relative to the position of the current block of video data in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block of video data. For example, for directional modes, intra-prediction unit 226 may generally mathematically combine values of neighboring samples and populate these calculated values in the defined direction across the current block of video data to produce the prediction block. As another example, for DC mode, intra-prediction unit 226 may calculate an average of the neighboring samples to the current block of video data and generate the prediction block to include this resulting average for each sample of the prediction block.

Mode selection unit 202 provides the prediction block to residual generation unit 204. Residual generation unit 204 receives a raw, unencoded version of the current block of video data from video data memory 230 and the prediction block from mode selection unit 202. Residual generation unit 204 calculates sample-by-sample differences between the current block of video data and the prediction block. The resulting sample-by-sample differences define a residual block for the current block of video data. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block of video data being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block of video data and the corresponding prediction block. Residual generation unit 204 then generates a residual block for the current block of video data. To generate the residual block, residual generation unit 204 calculates sample-by-sample differences between the prediction block and the current block of video data.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block of video data. Video encoder 200 (e.g., via mode selection unit 202) may adjust the degree of quantization applied to the transform coefficient blocks associated with the current block of video data by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block of video data (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples. In one or more examples, filter unit 216 may be configured to perform the example techniques described in this disclosure. For instance, filter unit 216 may be a NN-ILF, which may include backbone blocks as described, where the backbone blocks may be each associated with an attention block in which attention map 3204 is modified to generate modified attention map 3208 based on a size of the blocks used for training the NN-ILF.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to perform the example techniques described in this disclosure.

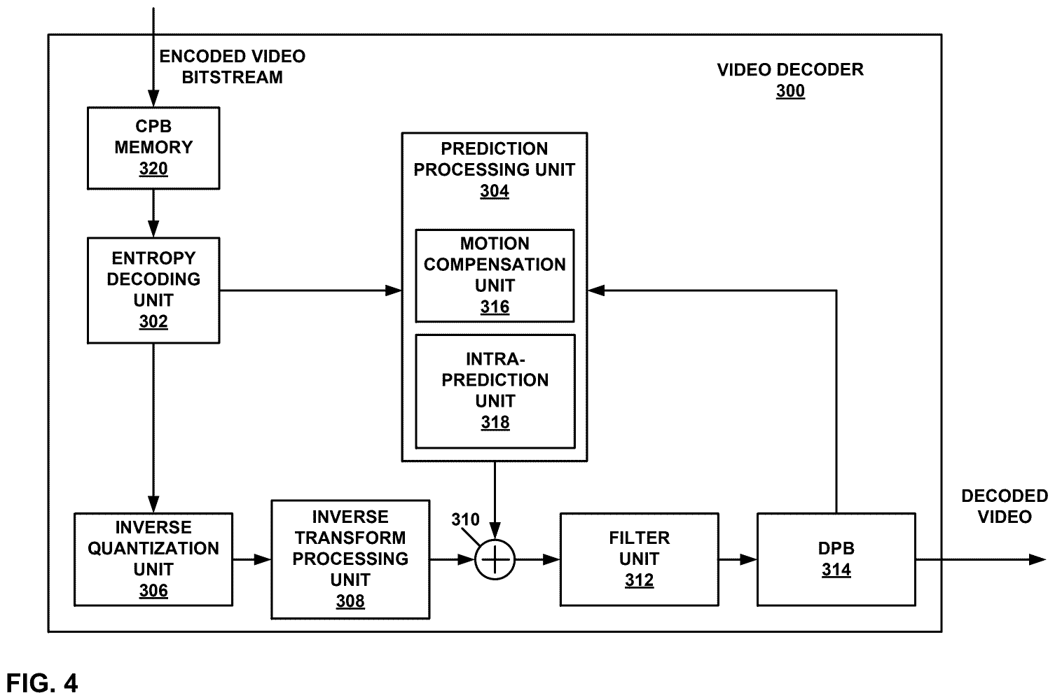

FIG. 4 is a block diagram illustrating an example video decoder 300 that may perform the techniques of this disclosure. FIG. 4 is provided for purposes of explanation and is not limiting on the techniques as broadly exemplified and described in this disclosure. For purposes of explanation, this disclosure describes video decoder 300 according to the techniques of VVC (ITU-T H.266, under development), and HEVC (ITU-T H.265). However, the techniques of this disclosure may be performed by video coding devices that are configured to other video coding standards.

In the example of FIG. 4, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 4 are illustrated to assist with understanding the operations performed by video decoder 300. The units may be implemented as fixed-function circuits, programmable circuits, or a combination thereof. Similar to FIG. 3, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block of video data”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block of video data. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block of video data is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block of video data in the current picture. Motion compensation unit 316 may generally perform the inter-prediction process in a manner that is substantially similar to that described with respect to motion compensation unit 224 (FIG. 3).

As another example, if the prediction information syntax elements indicate that the current block of video data is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 3). Intra-prediction unit 318 may retrieve data of neighboring samples to the current block of video data from DPB 314.

Reconstruction unit 310 may reconstruct the current block of video data using the prediction block and the residual block. For example, reconstruction unit 310 may add samples of the residual block to corresponding samples of the prediction block to reconstruct the current block of video data.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples. In one or more examples, filter unit 312 may be configured to perform the example techniques described in this disclosure. For instance, filter unit 312 may be a NN-ILF, which may include backbone blocks as described, where the backbone blocks may be each associated with an attention block in which attention map 3204 is modified to generate modified attention map 3208 based on a size of the blocks used for training the NN-ILF.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to perform the example techniques described in this disclosure.

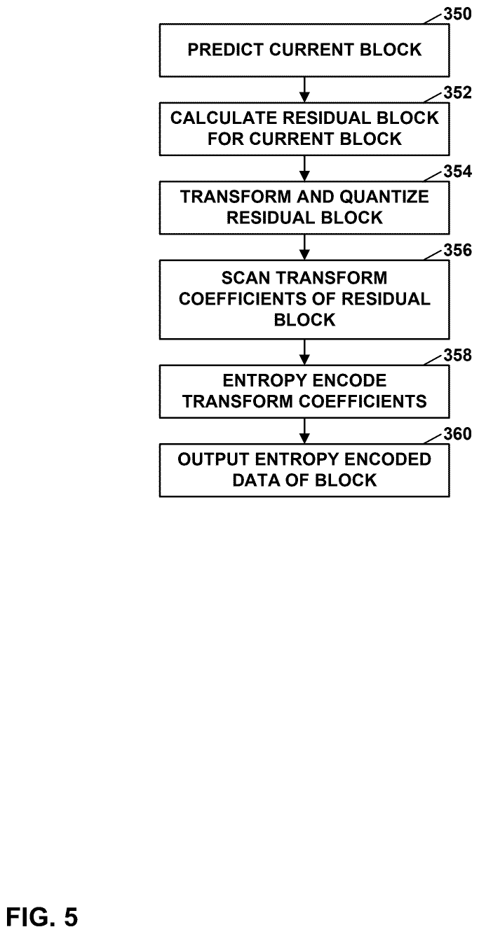

FIG. 5 is a flowchart illustrating an example method for encoding a current block of video data in accordance with the techniques of this disclosure. The current block of video data may comprise a current CU. Although described with respect to video encoder 200 (FIGS. 1 and 3), it should be understood that other devices may be configured to perform a method similar to that of FIG. 5.

In this example, video encoder 200 initially predicts the current block of video data (350). For example, video encoder 200 may form a prediction block for the current block of video data. Video encoder 200 may then calculate a residual block for the current block of video data (352). To calculate the residual block, video encoder 200 may calculate a difference between the original, unencoded block and the prediction block for the current block of video data. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

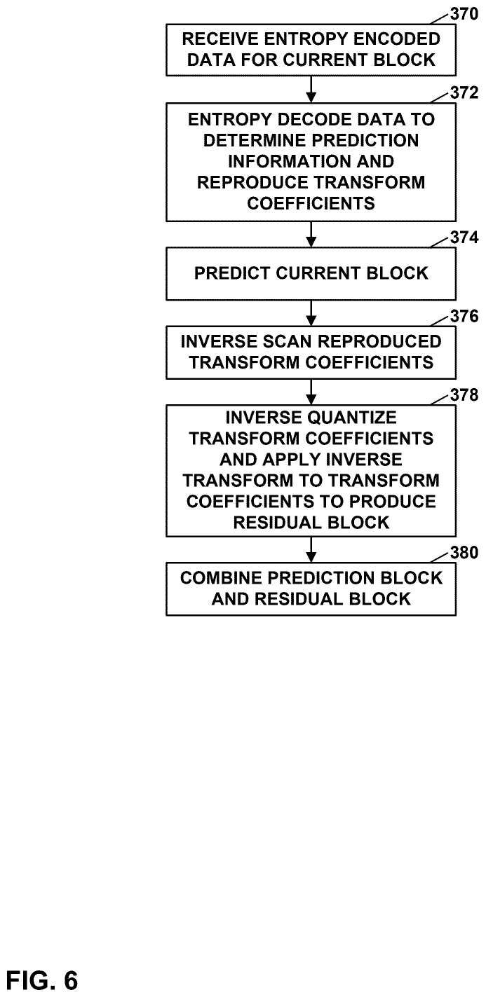

FIG. 6 is a flowchart illustrating an example method for decoding a current block of video data of video data in accordance with the techniques of this disclosure. The current block of video data may comprise a current CU. Although described with respect to video decoder 300 (FIGS. 1 and 4), it should be understood that other devices may be configured to perform a method similar to that of FIG. 6.

Video decoder 300 may receive entropy encoded data for the current block of video data, such as entropy encoded prediction information and entropy encoded data for transform coefficients of a residual block corresponding to the current block of video data (370). Video decoder 300 may entropy decode the entropy encoded data to determine prediction information for the current block of video data and to reproduce transform coefficients of the residual block (372). Video decoder 300 may predict the current block of video data (374), e.g., using an intra- or inter-prediction mode as indicated by the prediction information for the current block of video data, to calculate a prediction block for the current block of video data. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block of video data by combining the prediction block and the residual block (380).

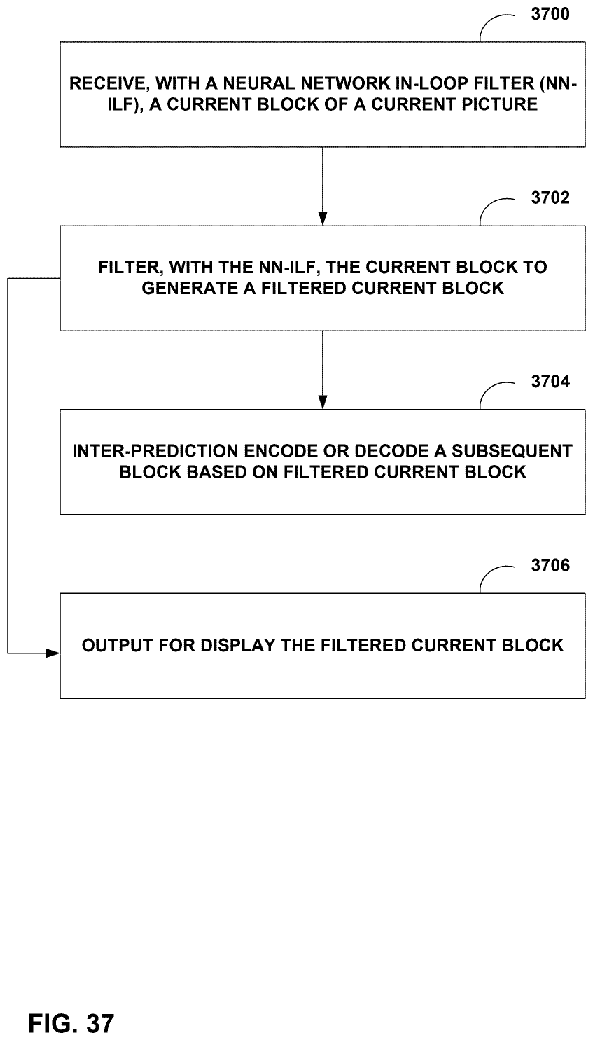

FIG. 37 is a flowchart illustrating an example method of processing video data. In one or more examples, processing circuitry of video encoder 200 or video decoder 300 (e.g., via filter unit 128, filter unit 216, or filter unit 312) may be configured to perform the example techniques of FIG. 37.

The processing circuitry may receive, with a neural network in-loop filter (NN-ILF) a current block of video data of a current picture (3700). Examples of the NN-ILF are illustrated in FIGS. 8-22 and FIG. 27. In general, the NN-ILF are trained with training blocks to generate the NN-ILF. In some examples, the current block of video data is inter-predicted, or the current picture may have a resolution greater than a threshold. For instance, the example techniques of FIG. 37 may not be performed for intra-predicted blocks or where the resolution is lower than the threshold, as non-limiting examples.

The processing circuitry may filter, with the NN-ILF, the current block of video data to generate a filtered current block of video data (3702). For example, the processing circuitry may filter the current block of video data using the example techniques described in this disclosure. That is, the NN-ILF may include a sequence of backbone blocks, as illustrated and as described above. Accordingly, the processing circuitry may filter, with a sequence of backbone blocks of the NN-ILF, the current block of video data. Each of the backbone blocks may be associated with a respective one of a plurality of attention blocks. The attention block(s) may be configured to generate an attention map 3204 that map modifier unit 3206 modifies to generate modified attention map 3208 that is used for filtering the current block of video data.

The processing circuitry may inter-prediction encode or decode a subsequent block based on the filtered current block of video data (3704). For instance, the processing circuitry may store the filtered current block of video data in a decoded picture buffer (DPB) for use for inter-predicting another block.

In some examples, the processing circuitry may output for display the filtered current block of video data (3706). For instance, in examples where the processing circuitry is for video decoder 300, the filtered current block of video data may be displayed with the reduced visual artifacts that are removed from the filtering using the techniques described in this disclosure.

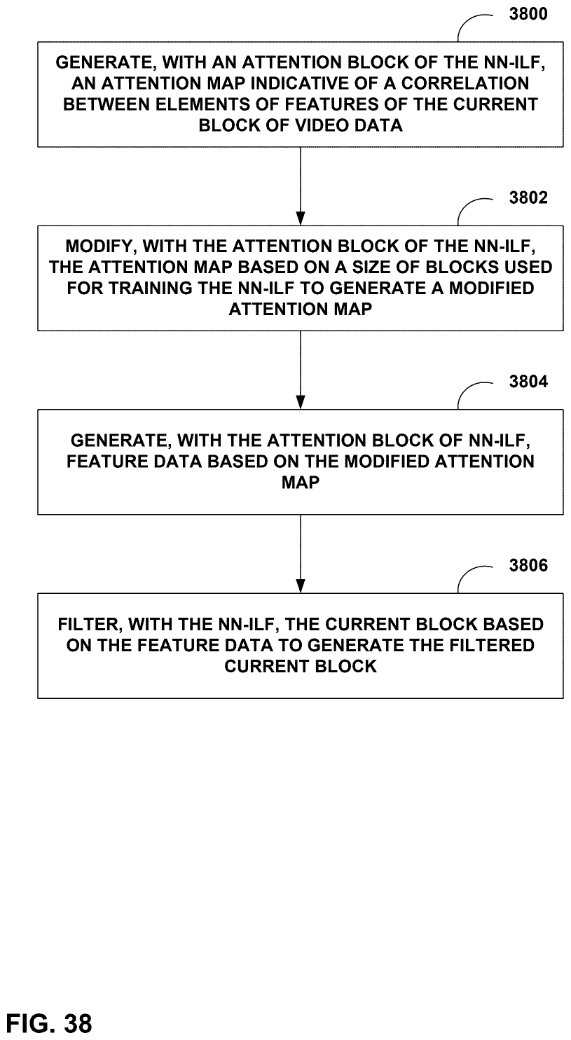

FIG. 38 is a flowchart illustrating an example method of processing video data. In one or more examples, processing circuitry of video encoder 200 or video decoder 300 (e.g., via filter unit 128, filter unit 216, or filter unit 312) may be configured to perform the example techniques of FIG. 38. For ease, reference is also made to FIGS. 32-36.

The processing circuitry may generate, with an attention block 3201 of the NN-ILF, an attention map 3204 indicative of correlation of elements of the features of the current block of video data (3800). That is, an attention map may be indicative of correlation (e.g., cross-correlation) between elements of the feature in a block (e.g., between color components of samples of the current block). In some examples, the cross-correlation/correlation may be computed with the spatial information between channels in the feature domain of the current block of video data, and this is represented as a set of weighting values. As one example, the attention map in the context of self-attention/transformer is produced by a transposed matrix multiplication of query and key. As described, the NN-ILF may include a sequence of backbone blocks used to filter the current block of video data. In some examples, each of the backbone blocks is associated with respective one of the plurality of attention blocks. For example, the NN-ILF may include backbone blocks as illustrated in FIGS. 33-36 that are ordered sequentially (e.g., cascading), and feature data generated by each of the backbone blocks is fed to the next backbone block. As illustrated in FIGS. 33-35, attention block 3201 may be in different locations within each of the backbone blocks.

There may be various ways in which to generate the attention map 3204. As one example, the processing circuitry may generate a query matrix (e.g., q value or q component) representing input values originating from the current block of video data for which the NN-ILF is identifying relevant context or information from other samples in the current picture, and generate a key matrix (e.g., k value or k component) representing information relevant to the query matrix. The processing circuitry may generate the attention map 3204 based on the query matrix and the key matrix, as illustrated in FIG. 32.

The processing circuitry may modify, with the attention block 3201 of the NN-ILF, the attention map 3204 based on a size of blocks used for training the NN-ILF to generate a modified attention map 3208 (3802). For example, map modifier unit 3206 may receive as input attention map 3204, and output modified attention map 3208.

There may be various ways in which map modifier unit 3206 may modify attention map 3204. As one example, map modifier unit 3206 may modify the attention map 3204 utilizing only linear operations.

As another example, map modifier unit 3206 may determine a scale factor based on a ratio of a number of samples in the current block of video data and a number of samples in a block used for training (e.g., each of the blocks used for training). In some examples, the scale factor may be equal to the ratio. In some examples, map modifier unit 3206 may determine a ratio value based on the ratio of the number of samples in the current block of video data and the size of the blocks used for training, and multiply the ratio value with a number greater than one to determine the scale factor. Map modifier unit 3206 may scale the attention map 3204 based on the scale factor to generate the modified attention map 3208.

As another example, map modifier unit 3206 may down-sample the attention map to match a resolution of the blocks used for training to generate the modified attention map 3208. In some examples, to down-sample, the processing circuitry may perform average pooling of the attention map 3208.

The processing circuitry may generate, with the attention block 3201 of the NN-ILF, feature data based on the modified attention map 3208 (3804). For instance, as illustrated in FIG. 32, the modified attention map 3208 is an input to another convolution layer, and the output of the convolution layer may be feature data that is used for filtering the current block of video data.

The processing circuitry may filter, with the NN-ILF, the current block of video data based on the feature data to generate the filtered current block of video data (3806). For example, as illustrated in FIGS. 33-36, the attention block 3201 may be in different locations within the backbone blocks, and as illustrated in FIGS. 8-22 and 27, the backbone blocks are arranged sequentially (e.g., cascading) where output from one backbone block feeds to the next backbone block. The attention block 3201 may generate the feature data that is fed to other components in the backbone block, or the output of a backbone block, and the output of the last backbone block is used to generate the filtered current block of video data (e.g., the luma and chroma components of the filtered current block of video data).

The following describes examples techniques that may be implemented together or separately.
Clause 1A. A method of processing video data, the method comprising: performing one or more example techniques described in this disclosure.
Clause 2A. A device for processing video data, the device comprising: one or more memories configured to store the video data; and processing circuitry coupled to the one or more memories and configured to perform one or more example techniques described in this disclosure.
Clause 3A. A device for processing video data, the device comprising one or more means for performing the method of one or more example techniques described in this disclosure.
Clause 4A. The device of clause 3A, wherein the one or more means comprise one or more processors implemented in circuitry.
Clause 5A. The device of any of clauses 3A and 4A, further comprising one or more memories to store the video data.
Clause 6A. The device of any of clauses 2A-5A, further comprising a display configured to display decoded video data.
Clause 7A. The device of any of clauses 2A-6A, wherein the device comprises one or more of a camera, a computer, a mobile device, a broadcast receiver device, or a set-top box.
Clause 8A. The device of any of clauses 2A-7A, wherein the device comprises a video decoder.
Clause 9A. The device of any of clauses 2A-8A, wherein the device comprises a video encoder.
Clause 10A. A computer-readable storage medium having stored thereon instructions that, when executed, cause one or more processors to perform the method of one or more example techniques described in this disclosure.
Clause 1B. A method of processing video data, the method comprising: receiving, with a neural network in-loop filter (NN-ILF), a current block of video data of a current picture; and filtering, with the NN-ILF, the current block of video data to generate a filtered current block of video data, wherein filtering the current block of video data comprises: generating, with an attention block of the NN-ILF, an attention map indicative of a correlation between elements of features of the current block of video data; modifying, with the attention block of the NN-ILF, the attention map based on a size of blocks used for training the NN-ILF to generate a modified attention map; generating, with the attention block of NN-ILF, feature data based on the modified attention map; and filtering, with the NN-ILF, the current block of video data based on the feature data to generate the filtered current block of video data.
Clause 2B. The method of clause 1B, wherein modifying the attention map comprises modifying the attention map utilizing only linear operations.
Clause 3B. The method of any of clauses 1B or 2B, wherein modifying the attention map comprises: determining a scale factor based on a ratio of a number of samples in the current block of video data and a number of samples in a block used for training; and scaling the attention map based on the scale factor to generate the modified attention map.
Clause 4B. The method of clause 3B, wherein determining the scale factor comprises: determining a ratio value based on the ratio of the number of samples in the current block of video data and the size of the blocks used for training; and multiplying the ratio value with a number greater than one to determine the scale factor.
Clause 5B. The method of any of clauses 1B-4B, wherein modifying the attention map comprises: down-sampling the attention map to match a resolution of the blocks used for training.
Clause 6B. The method of clause 5B, wherein down-sampling comprises average pooling the attention map.
Clause 7B. The method of any of clauses 1B-6B, wherein the attention block is one of a plurality of attention blocks, and wherein filtering, with the NN-ILF, the current block of video data to generate the filtered current block of video data comprises: filtering, with a sequence of backbone blocks of the NN-ILF, the current block of video data, wherein each of the backbone blocks is associated with respective one of the plurality of attention blocks.
Clause 8B. The method of any of clauses 1B-7B, wherein generating the attention map comprises: generating a query matrix representing input values originating from the current block of video data for which the NN-ILF is identifying relevant context or information from other samples in the current picture; generating a key matrix representing information relevant to the query matrix; and generating the attention map based on the query matrix and the key matrix.
Clause 9B. The method of any of clauses 1B-8B, further comprising decoding the current picture or a subsequent picture based on the filtered current block or encoding the current picture or a subsequent picture based on the filtered current block.
Clause 10B. The method of any of clauses 1B-9B, further comprising inter-prediction encoding or decoding a subsequent block based on the filtered current block of video data.
Clause 11B. A device for processing video data, the device comprising: one or more memories configured to store the video data; and processing circuitry coupled to the one or more memories, wherein the processing circuitry is configured to: receive, with a neural network in-loop filter (NN-ILF), a current block of video data of a current picture; and filter, with the NN-ILF, the current block of video data to generate a filtered current block of video data, wherein to filter the current block of video data, the processing circuitry is configured to: generate, with an attention block of the NN-ILF, an attention map indicative of a correlation between elements of features of the current block of video data; modify, with the attention block of the NN-ILF, the attention map based on a size of blocks used for training the NN-ILF to generate a modified attention map; generate, with the attention block of NN-ILF, feature data based on the modified attention map; and filter, with the NN-ILF, the current block of video data based on the feature data to generate the filtered current block of video data.
Clause 12B. The device of clause 11B, wherein to modify the attention map, the processing circuitry is configured to modify the attention map utilizing only linear operations.
Clause 13B. The device of any of clauses 11B and 12B, wherein to modify the attention map, the processing circuitry is configured to: determine a scale factor based on a ratio of a number of samples in the current block of video data and a number of samples in a block used for training; and scale the attention map based on the scale factor to generate the modified attention map.
Clause 14B. The device of clause 13B, wherein to determine the scale factor, the processing circuitry is configured to: determine a ratio value based on the ratio of the number of samples in the current block of video data and the size of the blocks used for training; and multiply the ratio value with a number greater than one to determine the scale factor.
Clause 15B. The device of any of clauses 11B-14B, wherein to modify the attention map, the processing circuitry is configured to: down-sample the attention map to match a resolution of the blocks used for training.
Clause 16B. The device of clause 15B, wherein to down-sample, the processing circuitry is configured to perform average pooling of the attention map.
Clause 17B. The device of any of clauses 11B-16B, wherein the attention block is one of a plurality of attention blocks, and wherein to filter, with the NN-ILF, the current block of video data to generate the filtered current block of video data, the processing circuitry is configured to: filter, with a sequence of backbone blocks of the NN-ILF, the current block of video data, wherein each of the backbone blocks is associated with respective one of the plurality of attention blocks.
Clause 18B. The device of any of clauses 11B-17B, wherein to generate the attention map, the processing circuitry is configured to: generate a query matrix representing input values originating from the current block of video data for which the NN-ILF is identifying relevant context or information from other samples in the current picture; generate a key matrix representing information relevant to the query matrix; and generate the attention map based on the query matrix and the key matrix.
Clause 19B. The device of any of clauses 11B-18B, wherein the processing circuitry is configured to inter-prediction encode or decode a subsequent block based on the filtered current block of video data.
Clause 20B. One or more computer-readable storage media storing instructions thereon that when executed cause one or more processors to: receive, with a neural network in-loop filter (NN-ILF), a current block of video data of a current picture; and filter, with the NN-ILF, the current block of video data to generate a filtered current block of video data, wherein the instructions that cause the one or more processors to filter the current block of video data comprise instructions that cause the one or more processors to: generate, with an attention block of the NN-ILF, an attention map indicative of a correlation between elements of features of the current block of video data; modify, with the attention block of the NN-ILF, the attention map based on a size of blocks used for training the NN-ILF to generate a modified attention map; generate, with the attention block of NN-ILF, feature data based on the modified attention map; and filter, with the NN-ILF, the current block of video data based on the feature data to generate the filtered current block of video data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing video data, the method comprising:
receiving, with a neural network in-loop filter (NN-ILF), a current block of video data of a current picture; and
filtering, with the NN-ILF, the current block of video data to generate a filtered current block of video data,
wherein filtering the current block of video data comprises:
generating, with an attention block of the NN-ILF, an attention map indicative of a correlation between elements of features of the current block of video data;
modifying, with the attention block of the NN-ILF, the attention map based on a size of blocks used for training the NN-ILF to generate a modified attention map;
generating, with the attention block of NN-ILF, feature data based on the modified attention map; and
filtering, with the NN-ILF, the current block of video data based on the feature data to generate the filtered current block of video data.

2. The method of claim 1, wherein modifying the attention map comprises modifying the attention map utilizing only linear operations.

3. The method of claim 1, wherein modifying the attention map comprises:
determining a scale factor based on a ratio of a number of samples in the current block of video data and a number of samples in a block used for training; and
scaling the attention map based on the scale factor to generate the modified attention map.

4. The method of claim 3, wherein determining the scale factor comprises:
determining a ratio value based on the ratio of the number of samples in the current block of video data and the number of samples in the block used for training; and
multiplying the ratio value with a number greater than one to determine the scale factor.

5. The method of claim 1, wherein modifying the attention map comprises:
down-sampling the attention map to match a resolution of the blocks used for training.

6. The method of claim 5, wherein down-sampling comprises average pooling the attention map.

7. The method of claim 1, wherein the attention block is one of a plurality of attention blocks, and wherein filtering, with the NN-ILF, the current block of video data to generate the filtered current block of video data comprises:
filtering, with a sequence of backbone blocks of the NN-ILF, the current block of video data, wherein each of the backbone blocks is associated with respective one of the plurality of attention blocks.

8. The method of claim 1, wherein generating the attention map comprises:
generating a query matrix representing input values originating from the current block of video data for which the NN-ILF is identifying relevant context or information from other samples in the current picture;
generating a key matrix representing information relevant to the query matrix; and
generating the attention map based on the query matrix and the key matrix.

9. The method of claim 1, further comprising decoding the current picture or a subsequent picture based on the filtered current block or encoding the current picture or a subsequent picture based on the filtered current block.

10. The method of claim 1, further comprising inter-prediction encoding or decoding a subsequent block based on the filtered current block of video data.

11. A device for processing video data, the device comprising:
one or more memories configured to store the video data; and
processing circuitry coupled to the one or more memories, wherein the processing circuitry is configured to:
receive, with a neural network in-loop filter (NN-ILF), a current block of video data of a current picture; and
filter, with the NN-ILF, the current block of video data to generate a filtered current block of video data,
wherein to filter the current block of video data, the processing circuitry is configured to:
generate, with an attention block of the NN-ILF, an attention map indicative of a correlation between elements of features of the current block of video data;
modify, with the attention block of the NN-ILF, the attention map based on a size of blocks used for training the NN-ILF to generate a modified attention map;
generate, with the attention block of NN-ILF, feature data based on the modified attention map; and
filter, with the NN-ILF, the current block of video data based on the feature data to generate the filtered current block of video data.

12. The device of claim 11, wherein to modify the attention map, the processing circuitry is configured to modify the attention map utilizing only linear operations.

13. The device of claim 11, wherein to modify the attention map, the processing circuitry is configured to:
determine a scale factor based on a ratio of a number of samples in the current block of video data and a number of samples in a block used for training; and
scale the attention map based on the scale factor to generate the modified attention map.

14. The device of claim 13, wherein to determine the scale factor, the processing circuitry is configured to:
determine a ratio value based on the ratio of the number of samples in the current block of video data and the number of samples in the block used for training; and
multiply the ratio value with a number greater than one to determine the scale factor.

15. The device of claim 11, wherein to modify the attention map, the processing circuitry is configured to:
down-sample the attention map to match a resolution of the blocks used for training.

16. The device of claim 15, wherein to down-sample, the processing circuitry is configured to perform average pooling of the attention map.

17. The device of claim 11, wherein the attention block is one of a plurality of attention blocks, and wherein to filter, with the NN-ILF, the current block of video data to generate the filtered current block of video data, the processing circuitry is configured to:
filter, with a sequence of backbone blocks of the NN-ILF, the current block of video data, wherein each of the backbone blocks is associated with respective one of the plurality of attention blocks.

18. The device of claim 11, wherein to generate the attention map, the processing circuitry is configured to:
generate a query matrix representing input values originating from the current block of video data for which the NN-ILF is identifying relevant context or information from other samples in the current picture;
generate a key matrix representing information relevant to the query matrix; and
generate the attention map based on the query matrix and the key matrix.

19. The device of claim 11, wherein the processing circuitry is configured to inter-prediction encode or decode a subsequent block based on the filtered current block of video data.

20. One or more computer-readable storage media storing instructions thereon that when executed cause one or more processors to:
receive, with a neural network in-loop filter (NN-ILF), a current block of video data of a current picture; and
filter, with the NN-ILF, the current block of video data to generate a filtered current block of video data,
wherein the instructions that cause the one or more processors to filter the current block of video data comprise instructions that cause the one or more processors to:
generate, with an attention block of the NN-ILF, an attention map indicative of a correlation between elements of features of the current block of video data;
modify, with the attention block of the NN-ILF, the attention map based on a size of blocks used for training the NN-ILF to generate a modified attention map;
generate, with the attention block of NN-ILF, feature data based on the modified attention map; and
filter, with the NN-ILF, the current block of video data based on the feature data to generate the filtered current block of video data.
